(19) United States
(12) Patent Application Publication
(10) Pub. No.: US 2026/0189983 A1
(43) Pub. Date: Jul. 2, 2026

(54) COMMUNICATION APPARATUS AND COMMUNICATION METHOD

(71) Applicant: SONY GROUP CORPORATION, TOKYO (JP)

(72) Inventors: HIROKI MATSUDA, TOKYO (JP); KAZUYUKI SHIMEZAWA, TOKYO (JP)

(21) Appl. No.: 19/129,032

(22) PCT Filed: Oct. 30, 2023
(86) PCT No.: PCT/JP2023/039073

§ 371 Date: May 12, 2025

(30) Foreign Application Priority Data
Nov. 16, 2022 (JP) 2022-183443

(51) Int. Cl. H04W 28/18; H04L 41/16; H04W 24/10; H04W 76/10

(52) U.S. Cl. CPC H04W 28/18; H04L 41/16; H04W 24/10; H04W 76/10

(57) ABSTRACT

A communication apparatus includes: a communication processing unit configured to receive first information generated by using a first model, from another communication apparatus; and a generation unit configured to generate second information from the first information by using a second model corresponding to the first model.

### FIELD

The present disclosure relates to a communication apparatus and a communication method.

### BACKGROUND

At present, as a next-generation mobile communication system, Beyond 5G and 6G have been examined in the 3rd Generation Partnership Project (3GPP).

The Beyond 5G and 6G radio access schemes are expected to achieve further improvements in high speed and high capacity (Enhanced Mobile Broadband (eMBB)), Massive Machine Type Communications (mMTC), and Ultra Reliable and Low Latency Communications (URLLC). In order to achieve these improvements, processing information transmitted and received by wireless communication by using an Artificial Intelligence/Machine Learning (AI/ML) model are currently examined. For example, Non Patent Literature 1 discusses a technique of improving frequency utilization efficiency by performing feedback of a channel state using machine learning.

### CITATION LIST

### Non Patent Literature

Non Patent Literature 1: R1-2207402, “Discussion on other aspects on AI/ML for CSI feedback enhancement”, Docomo, 3GPP TSG-RAN WG1 Meeting #110, Aug. 22-26, 2022

### SUMMARY

### Technical Problem

A technique of improving communication performance using artificial intelligence and machine learning has been examined in the 3rd Generation Partnership Project (3GPP). In recent years, there are demands for further improvement in communication performance (for example, improvement in frequency utilization efficiency, larger capacity, higher speed, lower latency, higher reliability, lower power consumption, or lower processing load). However, the conventional information transmission schemes in current situations are not likely to achieve expected communication performance.

The present disclosure is intended to solve the above problems, and proposes a communication apparatus and a communication method capable of achieving high communication performance.

Note that the above problem or target is merely one of a plurality of problems or targets that can be solved or achieved by a plurality of embodiments disclosed in the present specification.

### Solution to Problem

In order to solve the above problem, a communication apparatus according to one embodiment of the present disclosure includes: a communication processing unit configured to receive first information generated by using a first model, from another communication apparatus; and a generation unit configured to generate second information from the first information by using a second model corresponding to the first model.

### BRIEF DESCRIPTION OF DRAWINGS

FIG. 1 is a diagram illustrating outline of the present embodiment.

FIG. 2 is a diagram illustrating a configuration of a communication system according to the present embodiment.

FIG. 3 is a diagram illustrating a configuration of a management apparatus according to the present embodiment.

FIG. 4 is a diagram illustrating a configuration of a base station according to the present embodiment.

FIG. 5 is a diagram illustrating a configuration of a relay station according to the present embodiment.

FIG. 6 is a diagram illustrating a configuration of a terminal apparatus according to the present embodiment.

FIG. 7 is a diagram for illustrating a first model and a second model.

FIG. 8 is a diagram illustrating an overall picture of operation of the communication system.

FIG. 9 is a diagram for illustrating a first model and a second model.

FIG. 10 is a diagram illustrating an example of a learning model.

FIG. 11 is a diagram illustrating a transmission apparatus and a reception apparatus that perform communication by switching between a first signal processing scheme and a second signal processing scheme.

FIG. 12 is a sequence example illustrating Configured grant transmission processing of the present embodiment.

FIG. 13 is a sequence example illustrating handover processing of the present embodiment.

FIG. 14 is a sequence example illustrating sidelink communication processing of the present embodiment.

FIG. 15 is a sequence example illustrating a shared band communication processing of the present embodiment.

FIG. 16 is a sequence example illustrating uplink communication (Grant Based) of the present embodiment.

FIG. 17 is a sequence example illustrating Configured Grant transmission of the present embodiment.

FIG. 18 is a diagram illustrating another sequence example.

### DESCRIPTION OF EMBODIMENTS

Hereinafter, embodiments of the present disclosure will be described in detail with reference to the drawings. In the drawings, the same or corresponding elements are denoted by the same reference numerals, and detailed description thereof is omitted as appropriate.

Moreover, in the present specification and the drawings, a plurality of components having substantially the same functional configuration will be distinguished by attaching different alphabets or numbers after the same reference numerals. For example, a plurality of configurations having substantially the same functional configuration are distinguished as necessary, such as terminal apparatuses 40a, 40b, and 40c. However, when it is not particularly necessary to distinguish between the plurality of components having substantially the same functional configuration, only the same reference numeral is given. For example, when it is not necessary to distinguish between the terminal apparatuses 40a, 40b, and 40c, the apparatus is simply referred to as the terminal apparatus 40.

One or a plurality embodiments (examples and modifications) described below can each be implemented independently. On the other hand, at least some of the multiple embodiments described below may be appropriately combined with at least some of other embodiments. The plurality of embodiments may include novel features different from each other. Accordingly, the plurality of embodiments can contribute to achieving or solving different objects or problems, and can exhibit different effects.

### 1. Overview

A technique for improving communication performance using artificial intelligence and machine learning has been examined in 3GPP (registered trademark). In recent years, there are demands for further improvement in communication performance (for example, improvement in frequency utilization efficiency, larger capacity, higher speed, lower latency, higher reliability, lower power consumption, or lower processing load). However, the conventional information transmission schemes in current situations are not likely to achieve expected communication performance. For example, in next generation technologies, improvement in efficiency of transmission of information (for example, control information) using machine learning has been examined, but improvement in efficiency of transmission of information (for example, control information) is not considered to have been successfully achieved.

In view of these, the present embodiment proposes to solve the above problem as follows.

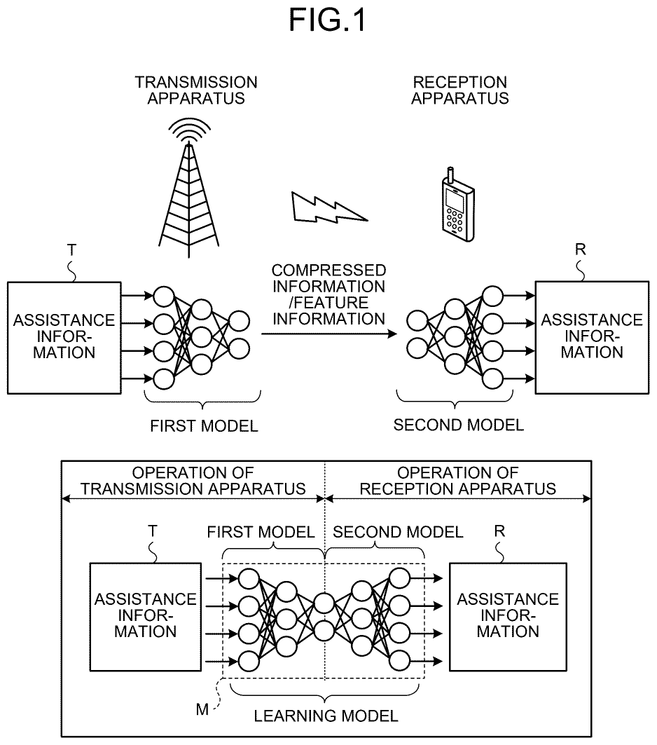

FIG. 1 is a diagram illustrating outline of the present embodiment. The communication system of the present embodiment includes a plurality of communication apparatuses that performs wireless communication. For example, the communication system includes: a communication apparatus (hereinafter, referred to as a transmission apparatus) on a transmission side of predetermined information (for example, assistance information described below): and a communication apparatus (hereinafter, referred to as a reception apparatus) on a reception side of the information. The transmission apparatus and the reception apparatus are interchangeable. In the example of FIG. 1, the transmission apparatus is illustrated as a base station, but the transmission apparatus is not limited to the base station. For example, the transmission apparatus may be any of a base station, a relay station, and a terminal apparatus. In the example of FIG. 1, the reception apparatus is illustrated as a terminal apparatus, but the reception apparatus is not limited to the terminal apparatus. For example, the transmission apparatus may be any of a base station, a relay station, and a terminal apparatus.

The transmission apparatus includes a learning model (first model) that generates first information from assistance information T (third information). The reception apparatus includes a learning model (second model) that generates assistance information R (second information) related to the assistance information T from the first information. Here, the first information is information obtained by compressing the assistance information T or information obtained by extracting a feature from the assistance information T. In the following description, the information obtained by compressing the assistance information T will be simply denoted as compressed information in some cases. In addition, in the following description, information obtained by extracting a feature from the assistance information T will be denoted as feature information in some cases. When the data amount of the feature information is smaller than the data amount of the assistance information T, the feature information can be compressed information.

Note that the assistance information is information necessary for the reception apparatus to perform processing related to wireless communication or information for assisting processing related to wireless communication, performed by the reception apparatus. For example, the assistance information is information (for example, control information) necessary for operations such as uplink data transmission, sidelink transmission, unlicensed communication, and handover (Hand Over) of the terminal apparatus. The assistance information R is information related to the assistance information T. At this time, the assistance information R may be information indicating the same information as the assistance information T, or may be information partially different from the assistance information T.

The first model is a learning model that generates the first information from the assistance information T. The second model is a learning model that generates the assistance information R from the first information. The first model and the second model each are a submodel of one learning model M. For example, it is assumed that the learning model M is a neural network. At this time, the first model may be a model including the first half (for example, a part of the input layer and an intermediate layer) of the learning model M. Furthermore, the second model may be a model including the second half (for example, the remaining portion of the intermediate layer and an output layer) of the learning model M. A submodel can also be regarded as a type of learning model.

Note that the learning model M of the present embodiment is configured such that the number of nodes in a central portion of the intermediate layer is smaller than the number of nodes in the input layer and the number of nodes in the output layer. Alternatively, the learning model M of the present embodiment is configured such that the dimension of the central portion of the intermediate layer is lower than the dimension of the input layer and the dimension of the output layer. That is, the first model is configured such that the number/dimension of nodes in the output layer is smaller/lower than the number/dimension of nodes in the input layer. Therefore, when the first information is generated from the third information by using the first model, a data amount of the first information is smaller than a data amount of the third information.

The transmission apparatus according to the present embodiment generates the first information (compressed information/feature information of assistance information T) from the third information (assistance information T) using the first model having such a configuration. Subsequently, the transmission apparatus transmits the generated first information to the reception apparatus. The reception apparatus receives the first information from the transmission apparatus. Subsequently, the reception apparatus generates the second information (assistance information R) from the first information by using the second model corresponding to the first model. Subsequently, using the second information, the transmission apparatus executes processing related to wireless communication (for example, signal processing for data transmission to the transmission apparatus).

In this manner, in the present embodiment, both the communication apparatuses on the transmission side and the reception side use a learning model in order to exchange information (for example, control information). This makes it possible for the communication system of the present embodiment to achieve further improvement in communication performance (for example, improvement in frequency utilization efficiency, larger capacity, higher speed, lower latency, higher reliability, lower power consumption, or lower processing load). For example, the learning model included in the communication apparatus of the present embodiment is configured such that the first information has a smaller data amount than the third information. This makes it possible for the communication system according to the embodiment to reduce the amount of information exchanged between the communication apparatuses, leading to improvement in the information transmission efficiency (improvement in frequency utilization efficiency).

The outline of the present embodiment has been described above. Hereinafter, a communication system 1 of the present embodiment will be described in detail.

### 2. Configuration of Communication System

First, a configuration of the communication system 1 will be described.

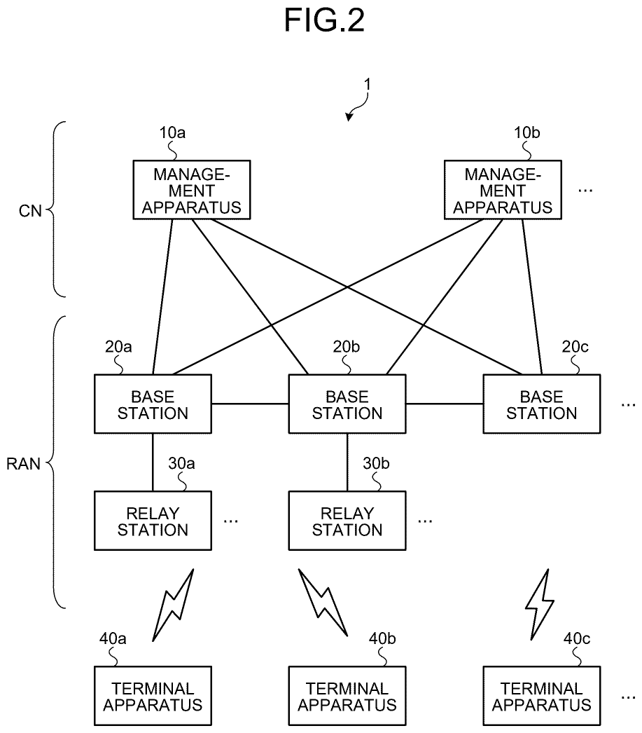

FIG. 2 is a diagram illustrating a configuration example of a communication system 1 according to the present embodiment. The communication system 1 includes a management apparatus 10, a base station 20, a relay station 30, and a terminal apparatus 40. With individual wireless communication apparatuses constituting the communication system 1 operating in cooperation with each other, the communication system 1 provides a user with a wireless network capable of mobile communication. The wireless network of the present embodiment includes a radio access network RAN and a core network CN, for example. In the present embodiment, the wireless communication apparatus is an apparatus having a wireless communication function, and in the example of FIG. 2, the apparatus corresponds to the base station 20, the relay station 30, and the terminal apparatus 40.

The communication system 1 may include a plurality of management apparatuses 10, a plurality of base stations 20, a plurality of relay stations 30, and a plurality of terminal apparatuses 40. In the example of FIG. 2, the communication system 1 includes management apparatuses 10a and 10b as the management apparatus 10, and includes base stations 20a, 20b, and 20c as the base stations 20. Furthermore, the communication system 1 includes relay stations 30a and 30b as the relay stations 30, and includes terminal apparatuses 40a, 40b, and 40c as the terminal apparatuses 40.

The terminal apparatus 40 may be configured to connect to the network using a Radio Access Technology (RAT) such as Long Term Evolution (LTE), New Radio (NR), Wi-Fi, or Bluetooth (registered trademark). At this time, the terminal apparatus 40 may be configured to be able to use different radio access technologies (wireless communication method). For example, the terminal apparatus 40 may be configured to be able to use NR and Wi-Fi. Furthermore, the terminal apparatus 40 may be configured to be able to use different cellular communication technologies (for example, LTE and NR). LTE and NR are a type of cellular communication technology, and enable mobile communication of terminal apparatuses by using cellular arrangement of a plurality of areas covered by base stations.

In the following, it is assumed that “LTE” includes LTE-advanced (LTE-A), LTE-advanced pro (LTE-A Pro), and evolved universal terrestrial radio access (EUTRA). In addition, it is assumed that NR includes new radio access technology (NRAT) and further EUTRA (FEUTRA). A single base station 20 may manage a plurality of cells. In the following, a cell corresponding to LTE may be referred to as an LTE cell, and a cell corresponding to NR may be referred to as an NR cell.

NR is the next generation (fifth generation) radio access technology subsequent to LTE (fourth generation communication including LTE-Advanced and LTE-Advanced Pro). The NR is a radio access technology that can support various use cases including Enhanced Mobile Broadband (eMBB), Massive Machine Type Communications (mMTC), and Ultra-Reliable and Low Latency Communications (URLLC). NR is standardized by Rel-15 of 3GPP (registered trademark) as a technical framework supporting a usage scenario, a requirements, a deployment scenario, and the like in these use cases, and is currently in technical expansion. Furthermore, Beyond 5G and 6G are required to simultaneously achieve a plurality of axes of high speed and large capacity, low latency/high reliability, and multiple simultaneous connection.

The wireless network may be compatible with a radio access technology (RAT) such as long term evolution (LTE) and new radio (NR). LTE and NR are a type of cellular communication technology, and enable mobile communication of terminal apparatuses by using cellular arrangement of a plurality of areas covered by base stations. The radio access scheme used by the communication system 1 is not limited to LTE and NR, and may be other radio access schemes such as wideband code division multiple access (W-CDMA) and code division multiple access 2000 (cdma 2000), for example.

The base station 20 and the relay station 30 may each be a terrestrial station or a non-terrestrial station. The non-terrestrial station may be a satellite station or an aircraft station. When the non-terrestrial station is a satellite station, the wireless network may be a Bent-pipe (Transparent) mobile satellite communication system.

In the present embodiment, the terrestrial station (also referred to as a terrestrial base station) refers to a base station or a relay station installed on the terrestrial. The “ground” represents not only a land but also a terrestrial location in a broad sense including underground, above-water, and underwater. Note that, in the following description, the description of “terrestrial station” may be referred to as a “gateway”.

The base station in LTE may be referred to as Evolved Node B (eNodeB) or eNB. NR base stations may be referred to as gNodeB or gNB. In LTE and NR, a terminal apparatus (also referred to as a mobile station, or terminal) may be referred to as user equipment (UE). The terminal apparatus is a type of communication apparatus, and is also referred to as a mobile station or a terminal.

The terminal apparatus 40 may be connectable to the network using a radio access technology (wireless communication method) other than LTE, NR, Wi-Fi, or Bluetooth. For example, the terminal apparatus 40 may be connectable to the network by using low power wide area (LPWA) communication. Furthermore, the terminal apparatus 40 may be connectable to the network using wireless communication of a proprietary standard.

Here, LPWA communication is wireless communication that enables low-power wide-range communication. For example, the LPWA wireless is Internet of Things (IoT) wireless communication using a specified low power wireless (for example, the 920 MHz band) or an Industry-Science-Medical (ISM) band. The LPWA communication used by the terminal apparatus 40 may conform to the LPWA standard. Examples of the LPWA standard include ELTRES, ZETA, SIGFOX, LoRaWAN, and NB-Iot. Needless to say, the LPWA standard is not to be limited thereto, and may be other LPWA standards.

Each wireless communication apparatus in FIG. 2 may be considered as an apparatus in a logical sense. That is, a part of each wireless communication apparatus may be implemented by a virtual machine (VM), a container, a docker, or the like, and they may be implemented on physically the same piece of hardware.

The communication system 1 may be compatible with a Radio Access Technology (RAT) such as Long Term Evolution (LTE) or New Radio (NR). LTE and NR are a type of cellular wireless communication technology, and enable mobile communication of the terminal apparatuses 40 by using cellular arrangement of a plurality of areas covered by the base station 20.

The radio access scheme of the communication system 1 is not limited to LTE or NR, and may be other radio access schemes such as wideband code division multiple access (W-CDMA) or code division multiple access 2000 (cdma 2000), for example.

In the present embodiment, the concept of the “wireless communication apparatus” includes not only a portable mobile apparatus (terminal apparatus) such as a mobile terminal but also an apparatus installed in a structure or a mobile body. The structure or a mobile body itself may be regarded as a wireless communication apparatus. In addition, the concept of the wireless communication apparatus includes not only the terminal apparatus 40 but also the base station 20 and the relay station 30. The wireless communication apparatus is a type of processing apparatus and information processing apparatus. The wireless communication apparatus can be rephrased as a transmission apparatus or a reception apparatus.

In the present embodiment, the resource indicates, for example, Frequency, Time, Resource Element (including REG, CCE, CORESET), Resource Block, Bandwidth Part, Component Carrier, Symbol, Sub-Symbol, Slot, Mini-Slot, Subslot, Subframe, Frame, PRACH occasion, Occasion, Code, Multi-access physical resource, Multi-access signature, and Subcarrier Spacing (Numerology), and the like.

Hereinafter, configurations of individual wireless communication apparatuses included in the communication system 1 will be specifically described. The configuration of each wireless communication apparatus illustrated below is just an example. The configuration of each wireless communication apparatus may differ from the configuration below.

### 2-1. Configuration of Management Apparatus

The management apparatus 10 is an apparatus that manages a wireless network. For example, the management apparatus 10 is an apparatus that manages communication of the base station 20. In a case where the core network CN is an Evolved Packet Core (EPC), the management apparatus 10 is an apparatus having a function as a Mobility Management Entity (MME), for example. When the core network CN is a 5G Core network (5GC), the management apparatus 10 is an apparatus having a function as an Access And Mobility Management Function (AMF) and/or a Session Management Function (SMF), for example. However, the functions of the management apparatus 10 are not limited to the MME, the AMF, or the SMF. When the core network CN is 5GC, the management apparatus 10 may be an apparatus having a function as a Network Slice Selection Function (NSSF), an Authentication Server Function (AUSF), or a Unified Data Management (UDM). The management apparatus 10 may be an apparatus having a function as a Home Subscriber Server (HSS).

Note that the management apparatus 10 may have a function of a gateway. For example, when the core network CN is EPC, the management apparatus 10 may have a function as a Serving Gateway (S-GW) or a Packet Data Network Gateway (P-GW). When the core network CN is a 5GC, the management apparatus 10 may have a function as a User Plane Function (UPF). The management apparatus 10 does not necessarily have to be an apparatus constituting the core network CN. When the core network CN is a core network of Wideband Code Division Multiple Access (W-CDMA) or Code Division Multiple Access 2000 (cdma 2000), the management apparatus 10 may be an apparatus that functions as a Radio Network Controller (RNC).

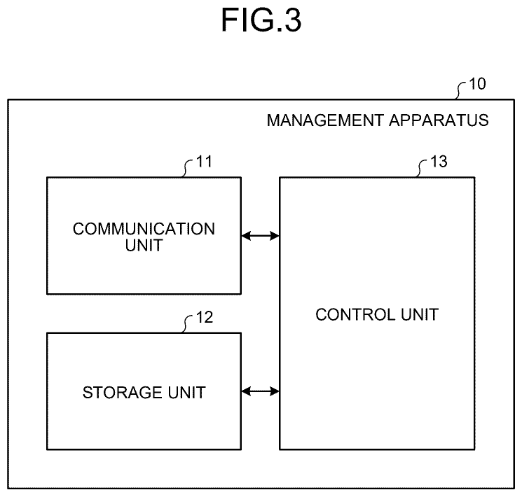

FIG. 3 is a diagram illustrating a configuration of the management apparatus 10 according to the present embodiment. The management apparatus 10 includes a communication unit 11, a storage unit 12, and a control unit 13. The configuration illustrated in FIG. 3 is a functional configuration, and the hardware configuration may be different from this configuration. The functions of the management apparatus 10 may be implemented in a statically or dynamically distributed form in a plurality of physically separated configurations. The management apparatus 10 may be constituted with a plurality of server apparatuses.

The communication unit 11 is a communication interface for communicating with a wireless communication apparatus (for example, the base station 20 or the relay station 30). The communication unit 11 may be a network interface, or may be a device connection interface. The communication unit 11 may be a local area network (LAN) interface such as a network interface card (NIC), or may be a universal serial bus (USB) interface including a USB host controller, a USB port, and the like. The communication unit 11 may be a wired interface, or may be a wireless interface. The communication unit 11 functions as a communication means of the management apparatus 10. The communication unit 11 is controlled by the control unit 13.

The storage unit 12 is a readable/writable storage device such as dynamic random access memory (DRAM), static random access memory (SRAM), flash memory, or a hard disk. The storage unit 12 functions as a storage means in the management apparatus 10. The storage unit 12 stores, for example, a connection state of the terminal apparatus 40. The storage unit 12 stores a radio resource control (RRC) state or an EPS connection management (ECM) state or a 5G system connection management (CM) state of the terminal apparatus 40. The storage unit 12 may function as a unit referred to as “home memory” (user information database) that stores the positional information of the terminal apparatus 40.

The control unit 13 is a controller that controls individual components of the management apparatus 10. The control unit 13 may be implemented by a processor such as a central processing unit (CPU) or a micro processing unit (MPU), for example. Specifically, the control unit 13 may be implemented by execution of various programs stored in the storage device inside the management apparatus 10 by the processor using random access memory (RAM) or the like as a work area. The control unit 13 may be implemented by an integrated circuit such as an application specific integrated circuit (ASIC) or a field programmable gate array (FPGA). The CPU, MPU, ASIC, and FPGA can all be regarded as controllers.

### 2-2. Configuration of Base Station

The base station 20 is a wireless communication apparatus that performs wireless communication with other wireless communication apparatuses (for example, the relay station 30, the terminal apparatus 40 or another base station 20). The base station 20 may wirelessly communicate with the terminal apparatus 40 via the relay station 30, or may directly perform wireless communication with the terminal apparatus 40.

The base station 20 is an apparatus corresponding to a radio base station (Base Station, Node B, eNB, gNB, etc.) or a radio access point. The base station 20 may be a radio relay station. The base station 20 may be an optical link apparatus referred to as a Remote Radio Head (RRH). Furthermore, the base station 20 may be a receiving station such as a Field Pickup Unit (FPU). The base station 20 may be an Integrated Access and Backhaul (IAB) donor node or an IAB relay node that provides a radio access channel and a radio backhaul channel by using time division multiplexing, frequency division multiplexing, or space division multiplexing.

The radio access technology used by the base station 20 may be a cellular communication technology. The radio access technology used by the base station 20 may be a wireless LAN technology. For example, the radio access technology used by the base station 20 may be a low power wide area (LPWA) communication technology. Note that the radio access technology used by the base station 20 is not limited thereto, and may be other radio access technologies. The wireless communication used by the base station 20 may be wireless communication using millimeter waves. The wireless communication used by the base station 20 may be wireless communication using radio waves or wireless communication using infrared rays or visible light, that is, optical wireless communication.

The base station 20 may be capable of Non-Orthogonal Multiple Access (NOMA) communication with the terminal apparatus 40. The NOMA communication is communication (transmission, reception, or both) using a non-orthogonal resource. The base station 20 may be capable of performing NOMA communication with another base station 20.

The base station 20 may be communicable with the core network CN via an interface between the base station 20 and the core network CN, for example, an S1 interface. This interface may be implemented as wired or wireless interface. The base station 20 may be communicable with another base station via an interface between base stations, such as an X2 interface, for example. This interface may be implemented as wired or wireless interface.

The base station (also referred to as a “base station apparatus”) conceptually includes not only a donor base station but also a relay base station (also referred to as a “relay station”). A base station conceptually includes not only a structure having a function of a base station but also a device installed in the structure.

The structure is, for example, a building such as a high-rise building, a house, a steel tower, a station facility, an airport facility, a port facility, or a stadium. The structure conceptually includes not only buildings but also non-building structures such as tunnels, bridges, dams, fences, and steel columns, as well as facilities such as cranes, gates, and windmills. The structure conceptually includes not only land-based (ground-based, in a narrow sense) structures or underground structures but also structures on the water, such as a jetty or a mega-float, and underwater structures such as an ocean observation facility. The base station can also be rephrased as an information processing apparatus.

The base station 20 may be a fixed station or a wireless communication apparatus configured to be movable, that is, a mobile station. The base station 20 may be an apparatus installed on a mobile body, or may be a mobile body itself. For example, a relay station having mobility can be regarded as the base station 20 as a mobile station. An apparatus originally having a mobile capability, such as an Unmanned Aerial Vehicle (UAV) typified by a vehicle or a drone, and a smartphone, equipped with at least a part of the functions of the base station, can also be regarded as the base station 20 as a mobile station.

The mobile body may be a mobile terminal such as a smartphone or a mobile phone. The mobile body may be a mobile body that moves on the land (ground in a narrow sense) (for example, a vehicle such as an automobile, a motorcycle, a bus, a truck, a motorbike, a train, or a linear motor car), or a mobile body (for example, subway) that moves under the ground (for example, through a tunnel).

The mobile body may be a mobile body that moves on the water (for example, a ship such as a passenger ship, a cargo ship, or a hovercraft), or a mobile body that moves underwater (for example, a submersible ship such as a submersible boat, a submarine, or an unmanned submarine).

The mobile body may be a mobile body that moves in the atmosphere (for example, an aircraft such as an airplane, an airship, or a drone).

The base station 20 may be a terrestrial base station (terrestrial station) installed on the ground. The base station 20 may be a base station disposed on a structure on the ground, or may be a base station installed in a mobile body moving on the ground. The base station 20 may be an antenna installed in a structure such as a building and a signal processing apparatus connected to the antenna. The base station 20 may be a structure or a mobile body itself. The “ground” represents not only a land (ground in a narrow sense) but also a terrestrial location in a broad sense including underground, above-water, and underwater. The base station 20 is not limited to a terrestrial base station. In a case where the communication system 1 is a satellite communication system, the base station 20 may be an aircraft station. From the perspective of a satellite station, an aircraft station located on the earth is a terrestrial station.

The base station 20 is not limited to a terrestrial station. The base station 20 may be a non-terrestrial base station (non-terrestrial station) capable of floating in the air or space. For example, the base station 20 may be an aircraft station or a satellite station.

The satellite station is a satellite station capable of floating outside the atmosphere. The satellite station may be an apparatus mounted on a space mobile body such as an artificial satellite, or may be a space mobile body itself. A space mobile body is a mobile body that moves outside the atmosphere. Examples of the space mobile body include artificial bodies such as artificial satellites, spacecraft, space stations, or probes.

The satellite serving as the satellite station may be any of a low earth orbiting (LEO) satellite, a medium earth orbiting (MEO) satellite, a geostationary earth orbiting (GEO) satellite, or a highly elliptical orbiting (HEO) satellite. The satellite station may be an apparatus mounted on a low earth orbiting satellite, a medium earth orbiting satellite, a geostationary earth orbiting satellite, or a highly elliptical orbiting satellite.

The aircraft station is a wireless communication apparatus capable of floating in the atmosphere, such as an aircraft. The aircraft station may be an apparatus mounted on an aircraft or the like, or may be an aircraft itself. The aircraft conceptually includes not only heavy aircraft such as an airplane or a glider but also light aircraft such as a balloon or an airship. The aircraft conceptually includes not only a heavy aircraft or a light aircraft but also a rotorcraft such as a helicopter or an auto-gyro. The aircraft station or an aircraft equipped with an aircraft station may be an unmanned aerial vehicle such as a drone.

The unmanned aerial vehicle conceptually includes an unmanned aircraft system (UAS) and a tethered UAS. The unmanned aircraft conceptually includes also a Lighter-than-Air (LTA) unmanned aircraft system (UAS) and a Heavier-than-Air (HTA) unmanned aircraft system (UAS). The unmanned aircraft conceptually includes also High Altitude unmanned aircraft system (UAS) platforms (HAPs).

The coverage of the base station 20 may be relatively large such as a macro cell or relatively small such as a pico cell. The coverage of the base station 20 may be extremely small such as a femto cell. The base station 20 may have a beamforming function. In this case, the base station 20 may form a cell or a service area for each beam.

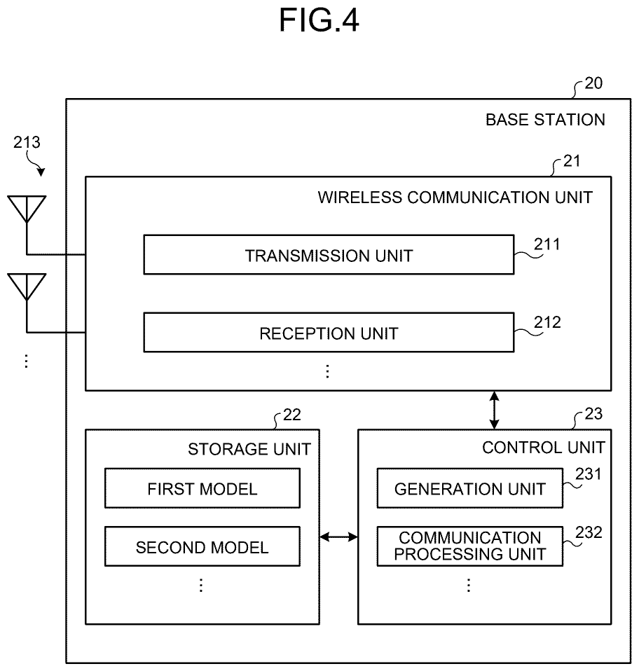

FIG. 4 is a diagram illustrating a configuration of the base station 20 according to the present embodiment. The base station 20 includes a wireless communication unit 21, a storage unit 22, and a control unit 23. The configuration illustrated in FIG. 4 is a functional configuration, and the hardware configuration may be different from this configuration. Furthermore, the functions of the base station 20 may be implemented in a distributed form in a plurality of physically separated configurations.

The wireless communication unit 21 is a signal processing unit for performing wireless communication with other wireless communication apparatuses (for example, the relay station 30, the terminal apparatus 40, or another base station 20). The wireless communication unit 21 is controlled by the control unit 23. The wireless communication unit 21 may support one or a plurality of radio access schemes. The wireless communication unit 21 may support both NR and LTE. The wireless communication unit 21 may support W-CDMA, cdma2000, and the like in addition to NR and LTE. The wireless communication unit 21 may support an automatic retransmission technology such as Hybrid Automatic Repeat reQuest (HARQ).

The wireless communication unit 21 includes a transmission unit 211, a reception unit 212, and an antenna 213. The wireless communication unit 21 may include a plurality of the transmission units 211, a plurality of the reception units 212, and a plurality of the antennas 213. In a case where the wireless communication unit 21 supports a plurality of radio access schemes, individual portions of the wireless communication unit 21 may be configured separately for each of the radio access schemes. For example, the transmission unit 211 and the reception unit 212 may be individually configured depending on LTE or NR. The antenna 213 may include a plurality of antenna elements, for example, a plurality of patch antennas. The wireless communication unit 21 may have a beamforming function. The wireless communication unit 21 may have a polarization beamforming function using vertically polarized waves (V-polarized waves) and horizontally polarized waves (H-polarized waves).

The transmission unit 211 performs transmission processing of downlink control information and downlink data. As an example, the transmission unit 211 performs coding of the downlink control information and the downlink data input from the control unit 23 by using a coding scheme such as block coding, convolutional coding, or turbo coding. The coding may be performed as coding using a polar code or a low density parity check (LDPC) code.

Next, the transmission unit 211 modulates the coded bits in accordance with a predetermined modulation scheme such as BPSK, QPSK, 16 QAM, 64 QAM, 256 QAM, or 1024 QAM. At this time, the signal points on the constellation do not necessarily have to be equidistant. That is, the constellation may be a Non Uniform Constellation (NUC).

Next, the transmission unit 211 multiplexes the modulation symbol of each channel and the downlink reference signal and allocates the multiplexed signals on a predetermined resource element. Next, the transmission unit 211 performs various types of signal processing on the multiplexed signal. As an example, the transmission unit 211 performs processing such as conversion to the frequency domain using fast Fourier transform, addition of a guard interval (cyclic prefix), generation of a baseband digital signal, conversion to an analog signal, quadrature modulation, upconvert, removal of extra frequency components, and power amplification. Finally, the signal generated by the transmission unit 211 is transmitted from the antenna 213.

The reception unit 212 processes an uplink signal received via the antenna 213. As an example, the reception unit 212 performs processing on the uplink signal, such as down-conversion, removal of unnecessary frequency components, amplification level control, orthogonal demodulation, conversion to digital signal, removal of guard interval (cyclic prefix), and frequency domain signal extraction using fast Fourier transform.

Next, the reception unit 212 demultiplexes an uplink channel such as a physical uplink shared channel (PUSCH) or a physical uplink control channel (PUCCH) and an uplink reference signal from the signal that has undergone these processing procedures. Next, the reception unit 212 demodulates a received signal in accordance with a modulation scheme such as Binary Phase Shift Keying (BPSK) or Quadrature Phase Shift Keying (QPSK) for the modulation symbol of the uplink channel. The modulation scheme may be schemes such as 16 Quadrature Amplitude Modulation (QAM), 64 QAM, or 256 QAM. At this time, the signal points on the constellation do not necessarily have to be equidistant. That is, the constellation may be a non-uniform constellation.

The reception unit 212 performs decoding processing on the demodulated coded bits of the uplink channel. Finally, the decoded uplink data and uplink control information are output to the control unit 23.

The antenna 213 is an antenna apparatus that performs mutual conversion of a current and a radio wave. The antenna 213 may include one antenna element, for example, one patch antenna. Furthermore, the antenna 213 may include a plurality of antenna elements (for example, a plurality of patch antennas). In a case where the antenna 213 includes a plurality of antenna elements, the wireless communication unit 21 may have a beamforming function. The wireless communication unit 21 may control the directivity of a radio signal using a plurality of antenna elements to generate a directional beam. The antenna 213 may be a dual polarized antenna. In a case where the antenna 213 is a dual polarized antenna, the wireless communication unit 21 may use vertically polarized waves (V-polarized waves) and horizontally polarized waves (H-polarized waves) when transmitting the radio signal. The wireless communication unit 21 may control the directivity of the radio signal transmitted using the vertically polarized wave and the horizontally polarized wave.

The transmission unit 211 performs transmission processing of downlink control information and downlink data. At this time, the transmission unit 211 may transmit the information (first information) processed using the learning model to another wireless communication apparatus.

The reception unit 212 processes an uplink signal received via the antenna 213. Note that the reception unit 212 may receive information (fourth information) used to generate the assistance information from another wireless communication apparatus.

The storage unit 22 is a readable/writable storage device such as DRAM, SRAM, flash memory, or a hard disk. The storage unit 22 functions as a storage means in the base station 20. The storage unit 22 may store information of one or both of the first model and the second model. The first model and the second model will be described below.

The control unit 23 is a controller that controls individual parts of the base station 20. The control unit 23 controls the wireless communication unit to perform wireless communication with another wireless communication apparatus (for example, the relay station 30, the terminal apparatus 40, or another base station 20). The control unit 23 may be implemented by a processor such as a CPU or an MPU. Specifically, the control unit 23 may be implemented by a processor executing various programs stored in a storage device inside the base station 20 using the RAM or the like as a work area. The control unit 23 may be implemented by an integrated circuit such as an ASIC or an FPGA. The CPU, MPU, ASIC, and FPGA can all be regarded as controllers. Furthermore, the control unit 23 may be implemented by a Graphics Processing Unit (GPU) in addition to or in place of the CPU.

The control unit 23 includes a generation unit 231 and a communication processing unit 232. Individual blocks (generation unit 231 to communication processing unit 232) constituting the control unit 23 are functional blocks individually indicating functions of the control unit 23. These functional blocks may be software blocks or hardware blocks. For example, each of the functional blocks described above may be one software module realized by software (including a microprogram) or one circuit block on a semiconductor chip (die). Needless to say, each of the functional blocks may be formed as one processor or one integrated circuit. Note that the control unit 23 may be configured in a functional unit different from the above-described functional block. The functional block may be configured by using any method.

The generation unit 231 generates various types of information to be transmitted to another communication apparatus. The generation unit 231 generates the first information (compressed information/feature information of assistance information T) from the third information (for example, the assistance information T) using the first model.

The communication processing unit 232 transmits various types of information to another communication apparatus via the transmission unit 211 of the wireless communication unit 21. For example, the communication processing unit 232 transmits the first information generated by the generation unit 231 to another communication apparatus (for example, the terminal apparatus 40). Furthermore, the communication processing unit 232 receives various types of information from another communication apparatus via the reception unit 212 of the wireless communication unit 21. For example, the communication processing unit 232 receives the fourth information used for generating the third information from another communication apparatus (for example, the terminal apparatus 40). Note that the communication processing unit 232 can be rephrased as a communication control unit. Furthermore, the communication processing unit 232 may be divided into a transmission processing unit (transmission control unit) and a reception processing unit (reception control unit).

In addition, the operations of the generation unit 231 and the communication processing unit 232 may be similar to the operation of each functional block of the control unit 43 of the terminal apparatus 40. Furthermore, the operation of the generation unit 231 and the communication processing unit 232 may be similar to the operation of each functional block of the control unit 33 of the relay station 30. The operations of the generation unit 231 and the communication processing unit 232 will be described in detail below.

In some embodiments, the base station 20 may be configured by a set of a plurality of physical or logical apparatuses. As an example, the base station 20 in the present embodiment may be classified into a plurality of apparatuses such as a Baseband Unit (BBU) and a Radio Unit (RU). The base station 20 may be construed as a set of the plurality of apparatuses. In addition, the base station may be either one or both of the BBU and the RU. The BBU and the RU may be connected to each other via a predetermined interface (for example, an enhanced Common Public Radio Interface (eCPRI)).

The RU may be referred to as a Remote Radio Unit (RRU) or a Radio DoT (RD). The RU may support a gNB Distributed Unit (gNB-DU) described below. The BBU may support a gNB Central Unit) (gNB-CU) described below. The RU may be an apparatus integrally formed with an antenna. An antenna of the base station 20, for example, an antenna integrally formed with an RU, may employ an Advanced Antenna System and support MIMO (for example, FD-MIMO) or beamforming. For example, the antenna of the base station 20 may include 64 transmitting antenna ports and 64 receiving antenna ports.

The antenna mounted on the RU may be an antenna panel including one or more antenna elements, and the RU may include one or more antenna panels. The RU may be equipped with two types of antenna panels: a horizontally polarized antenna panel and a vertically polarized antenna panel. The RU may be equipped with two types of antenna panels: a right-handed circularly polarized antenna panel and a left-handed circularly polarized antenna panel. The RU may form and control an independent beam for each antenna panel.

The plurality of base stations 20 may be connected to each other. One or the plurality of base stations 20 may be included in a Radio Access Network (RAN). That is, the base station 20 may be simply referred to as a RAN, a RAN node, an Access Network (AN), an AN node, or the like. RAN in LTE is sometimes referred to as Enhanced Universal Terrestrial RAN (EUTRAN). RAN in NR may be referred to as NGRAN. RAN in W-CDMA (UMTS) may be referred to as UTRAN.

The base station 20 in LTE may be referred to as Evolved Node B (eNodeB) or eNB. That is, EUTRAN includes one or a plurality of eNodeB (eNB). NR base stations 20 may be referred to as gNodeB or gNB. At this time, NGRAN contains one or a plurality of gNBs. EUTRAN may include gNB (en-gNB) connected to the core network (EPC) in LTE communication systems (EPS). NGRAN may include an ng-eNB connected to the core network 5GC in a 5G communication system (5GS).

When the base station 20 is eNB or gNB, etc., the base station 20 may be referred to as 3GPP access. When the base station 20 is a radio access point, the base station 20 may be referred to as non-3GPP access. The base station 20 may be an optical link apparatus referred to as a Remote Radio Head (RRH). Furthermore, in a case where the base station 20 is a gNB, the base station 20 may be a combination of the gNB-CU and the gNB-DU described above, or may be any of the gNB-CU and the gNB-DU.

The gNB-CU hosts a plurality of upper layers (for example, RRC, SDAP, and PDCP, etc.) of the Access Stratum for communication with the UE. The gNB-DU hosts a plurality of lower layers (for example, RLC, MAC, and PHY, etc.) of the Access Stratum. Among messages/information to be described below, RRC signaling (semi-static notification) may be generated by the gNB-CU, while MAC CE and DCI (dynamic notification) may be generated by the gNB-DU. Alternatively, among the RRC configurations (semi-static notifications), some configurations such as IE: cellGroupConfig may be generated by the gNB-DU, while the remaining configurations may be generated by the gNB-CU, for example. These configurations may be transmitted and received through an F1 interface described below.

The base station 20 may be configured to be able to communicate with another base station. When the plurality of base stations 20 are eNBs or a combination of an eNB and an en-gNB, these base stations 20 may be connected by an X2 interface. When the plurality of base stations 20 are gNBs or a combination of a gn-eNB and a gNB, these base stations 20 may be connected by an Xn interface. When the plurality of base stations 20 are a combination of a gNB-CU and a gNB-DU, these base stations 20 may be interconnected by the F1 interface described above. A message/information (for example, RRC signaling, MAC Control Element (MAC CE), Downlink Control Information (DCI), or the like) to be described below may be transmitted among the plurality of base stations 20 via an interface such as an X2 interface, an Xn interface, an F1 interface, for example.

The cell provided by the base station 20 may be referred to as a serving cell. The serving cell conceptually includes a primary cell (PCell) and a secondary cell (SCell). When dual connectivity is provided to the terminal apparatus 40, the PCell provided by a Master Node (MN) and zero or one or more SCells may be referred to as a Master Cell Group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity, etc.

The serving cell may include a Primary Secondary Cell or Primary SCG Cell (PSCell). In a case where dual connectivity is provided to the terminal apparatus 40, the PSCell and the zero or one or more SCells provided by a secondary node (SN) may be referred to as Secondary Cell Group (SCG). Unless specially configured (for example, PUCCH on SCell), a physical uplink control channel (PUCCH) is transmitted by the PCell and the PSCell, but is not transmitted by the SCell. The radio link failure is also detected by the PCell and the PSCell, but is not detected by the SCell (need not be detected). In this manner, since the PCell and the PSCell have a special role in the serving cell, these cells are also referred to as Special Cells (SpCells).

One cell may be associated with one downlink component carrier and one uplink component carrier. The system bandwidth corresponding to one cell may be divided into a plurality of bandwidth parts (BWPs). In this case, one or a plurality of BWPs may be configured for the terminal apparatus 40, and one BWP may be used for the terminal apparatus 40 as an active BWP. Radio resources (for example, a frequency band, a numerology (subcarrier spacing), and a slot format (slot configuration)) usable by the terminal apparatus 40 may be different for each cell, each component carrier, or each BWP.

### 2-3. Configuration of Relay Station

The relay station 30 is a wireless communication apparatus serving as a repeater of the base station 20. The relay station 30 is a type of base station. The relay station 30 is a type of information processing apparatus. The relay station 30 can also be referred to as a relay base station. For example, the relay station 30 may be an apparatus referred to as a repeater (for example, RF Repeater, Smart Repeater, or Intelligent Surface). The relay station 30 is a wireless communication apparatus that performs wireless communication with other wireless communication apparatuses (for example, the base station 20, another relay station 30, or the terminal apparatus 40).

The relay station 30 may be capable of performing NOMA communication with the terminal apparatus 40. The relay station 30 relays communication between the base station 20 and the terminal apparatus 40. The relay station 30 may be capable of performing wireless communication with another relay station 30 and the base station 20. The relay station 30 may be a terrestrial station apparatus or a non-terrestrial station apparatus. The relay station 30 constitutes a radio access network RAN together with the base station 20.

The relay station 30 may be a fixed apparatus, a movable apparatus, or a floating apparatus. The size of the coverage of the relay station 30 is not limited to a specific size. The cell covered by the relay station 30 may be a macro cell, a micro cell, or a small cell.

The relay station 30 may be mounted on any type of apparatus as long as the function of relay is satisfied. The relay station 30 may be mounted on a terminal apparatus such as a smartphone, may be mounted on an automobile, a train or a human-powered vehicle, may be mounted on a balloon, an airplane, or a drone, or on a home appliance such as a television, a game machine, an air conditioner, a refrigerator, or a lighting fixture, etc.

The configuration of the relay station 30 may be similar to the configuration of the base station 20 described above. Similarly to the base station 20 described above, the relay station 30 may be an apparatus installed on a mobile body, or may be a mobile body itself. Here, the mobile body may be a mobile terminal such as a smartphone or a mobile phone, as described above. The mobile body may be a mobile body that moves on land (on the ground in a narrow sense) or may be a mobile body that moves in the ground. The mobile body may be a mobile body that moves over water or may be a mobile body that moves under water. The mobile body may be a mobile body that moves inside the atmosphere or may be a mobile body that moves outside the atmosphere. The relay station 30 may be a terrestrial station apparatus or a non-terrestrial station apparatus. The relay station 30 may be an aircraft station or a satellite station.

The coverage of the relay station 30 may be large such as a macro cell or small such as a pico cell, similarly to the base station 20. The coverage of the relay station 30 may be extremely small such as a femto cell. The relay station 30 may have a beamforming function. The relay station 30 may form a cell or a service area for each beam.

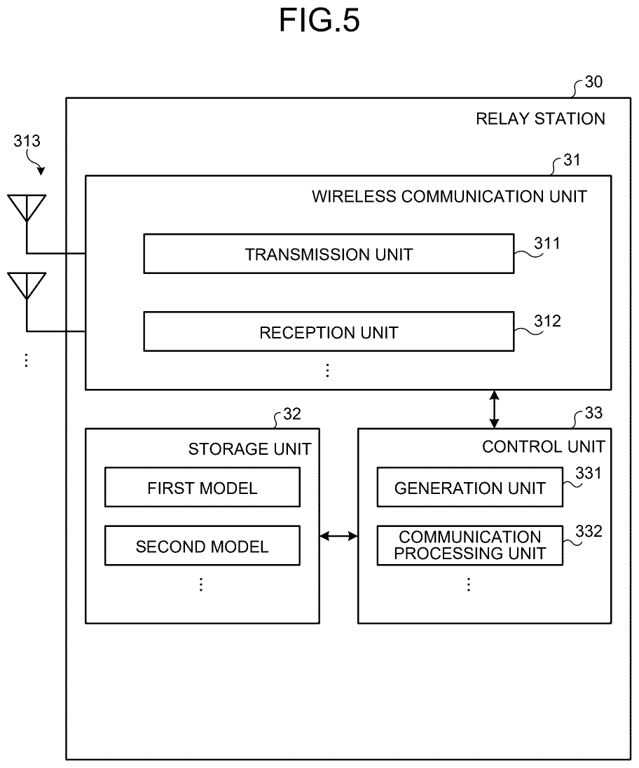

FIG. 5 is a diagram illustrating a configuration of the relay station 30 according to the present embodiment. The relay station 30 includes a wireless communication unit 31, a storage unit 32, and a control unit 33. The configuration illustrated in FIG. 5 is a functional configuration, and the hardware configuration may be different from this. Furthermore, the functions of the relay station 30 may be implemented in a distributed manner in a plurality of physically separated configurations.

The wireless communication unit 31 is a signal processing unit for performing wireless communication with other wireless communication apparatuses (for example, the base station 20, the terminal apparatus 40, or another relay station 30). The wireless communication unit 31 may support one or a plurality of radio access schemes. For example, the wireless communication unit 31 may support both NR and LTE. The wireless communication unit 31 may support W-CDMA, cdma3000, and the like in addition to NR and LTE.

The wireless communication unit 31 includes a transmission unit 311, a reception unit 312, and an antenna 313. The wireless communication unit 31 may include a plurality of the transmission units 311, a plurality of the reception units 312, and a plurality of the antennas 313. In a case where the wireless communication unit 31 supports a plurality of radio access schemes, individual portions of the wireless communication unit 31 may be configured separately for each of the radio access schemes. For example, the transmission unit 311 and the reception unit 312 may be individually configured depending on LTE or NR. The configurations of the transmission unit 311, the reception unit 312, and the antenna 313 may be similar to the configurations of the transmission unit 211, the reception unit 212, and the antenna 213 of the base station 20 described above, respectively. The wireless communication unit 31 may have a beamforming function similarly to the wireless communication unit 21 of the base station 20.

The storage unit 32 is a readable/writable storage device such as DRAM, SRAM, flash memory, or a hard disk. The storage unit 32 functions as a storage means in the relay station 30. The configuration and function of the storage unit 32 may be similar to the configuration and function of the storage unit 22 of the base station 20 described above. The storage unit 32 may store information of one or both of the first model and the second model. The first model and the second model will be described below.

The control unit 33 is a controller that controls individual parts of the relay station 30. The control unit 33 may be implemented by a processor such as a CPU or an MPU. For example, the control unit 33 is implemented by the processor executing various programs stored in the storage device inside the relay station 30 using RAM or the like as a work area. The control unit 33 may be implemented by an integrated circuit such as an ASIC or an FPGA. The CPU, MPU, ASIC, and FPGA can all be regarded as controllers. The control unit 33 may be implemented by a GPU in addition to the CPU or in place of the CPU. The configuration and function of the control unit 33 may be similar to the configuration and function of the control unit 23 of the base station 20 described above.

The control unit 33 includes a generation unit 331 and a communication processing unit 332. Individual blocks (the generation unit 331 to the communication processing unit 332) constituting the control unit 33 are functional blocks individually indicating functions of the control unit 33. These functional blocks may be software blocks or hardware blocks. For example, each of the functional blocks described above may be one software module realized by software (including a microprogram) or one circuit block on a semiconductor chip (die). Needless to say, each of the functional blocks may be formed as one processor or one integrated circuit. Note that the control unit 33 may be configured in a functional unit different from the above-described functional block. The functional block may be configured by using any method.

The operations of the generation unit 331 and the communication processing unit 332 may be similar to those of the generation unit 231 or the communication processing unit 232 of the base station 20, respectively. In addition, the operations of the generation unit 331 and the communication processing unit 332 may be similar to the operation of each functional block of the control unit 43 of the terminal apparatus 40.

Note that the relay station 30 may be an IAB relay node. The relay station 30 operates as IAB-mobile termination (IAB-MT) for an IAB donor node that provides backhaul, and operates as an IAB-distributed unit (IAB-DU) for the terminal apparatus 40 that provides access. The IAB donor node may be the base station 20, for example, and operates as an IAB-Central Unit (IAB-CU).

### 2-4. Configuration of Terminal Apparatus

The terminal apparatus 40 is a wireless communication apparatus that performs wireless communication with another wireless communication apparatus (for example, the base station 20, the relay station 30, or another terminal apparatus 40, etc.). The terminal apparatus 40 may be a mobile terminal such as a mobile phone, a smart device (smartphone or tablet), a personal digital assistant (PDA), or a laptop PC, for example. The terminal apparatus 40 may be an imaging apparatus (for example, a camcorder) having a communication function. The terminal apparatus 40 may be a motorcycle, a moving relay vehicle, or the like, equipped with a communication device such as the field pickup unit (FPU). The terminal apparatus 40 may be a Machine to Machine (M2M) device or an Internet of Things (IoT) device. The terminal apparatus 40 may be a wearable device such as a smart watch.

The terminal apparatus 40 may be an xR device such as an augmented reality (AR) device, a virtual reality (VR) device, or a mixed reality (MR) device. At this time, the xR device may be an eyeglass-type device such as AR glasses or MR glasses, or may be a head-mounted device such as a VR head-mounted display. In a case where the terminal apparatus 40 is an xR device, the terminal apparatus 40 may be a standalone device including only a portion worn on the user (for example, the eyeglass portion). Furthermore, the terminal apparatus 40 may be a terminal-linked device including the portion worn on the user (for example, the eyeglass portion) and a terminal portion (for example, a smart device) linked with the portion worn on the user.

The terminal apparatus 40 may be capable of performing NOMA communication with the base station 20. The terminal apparatus 40 may be able to use an automatic retransmission technology such as HARQ when communicating with the base station 20. The terminal apparatus 40 may be capable of sidelink communication with another terminal apparatus 40. The terminal apparatus 40 may be capable of using an automatic retransmission technology such as HARQ when performing sidelink communication. The terminal apparatus 40 may be able to perform NOMA communication when performing sidelink communication with another terminal apparatus 40. The terminal apparatus 40 may be able to perform LPWA communication with another wireless communication apparatus such as the base station 20. The wireless communication used by the terminal apparatus 40 may be wireless communication using millimeter waves. The wireless communication (including sidelink communication) used by the terminal apparatus 40 may be wireless communication using radio waves or wireless communication using infrared rays or visible light, namely, optical wireless communication.

The terminal apparatus 40 may be a movable wireless communication apparatus, that is, a mobile apparatus. Furthermore, the terminal apparatus 40 may be a wireless communication apparatus installed on a mobile body, or may be the mobile body itself. The terminal apparatus 40 may be a vehicle that moves on a road, such as an automobile, a bus, a truck, or a motorbike, or may be a wireless communication apparatus mounted on the vehicle. The mobile body may be a mobile terminal, or may be a mobile body that moves on land (on the ground in a narrow sense), in the ground, on water, or under water. The mobile body may be a mobile body that moves inside the atmosphere, such as a drone or a helicopter, or may be a mobile body that moves outside the atmosphere, such as an artificial satellite.

The terminal apparatus 40 may be capable of performing communication while being simultaneously connected to a plurality of base stations 20 or a plurality of cells. For example, when one base station 20 supports a communication area via a plurality of cells (for example, pCell and sCell), it is possible to bundle the plurality of cells and communicate between the base station 20 and the terminal apparatus 40 by using a carrier aggregation (CA) technology, a dual connectivity (DC) technology, or a multi-connectivity (MC) technology. Alternatively, the terminal apparatus 40 and the plurality of base stations 20 can communicate with each other by a Coordinated Multi-Point Transmission and Reception (CoMP) technology via cells of different base stations 20.

The terminal apparatus 40 may be a relay terminal that relays communication to a remote terminal.

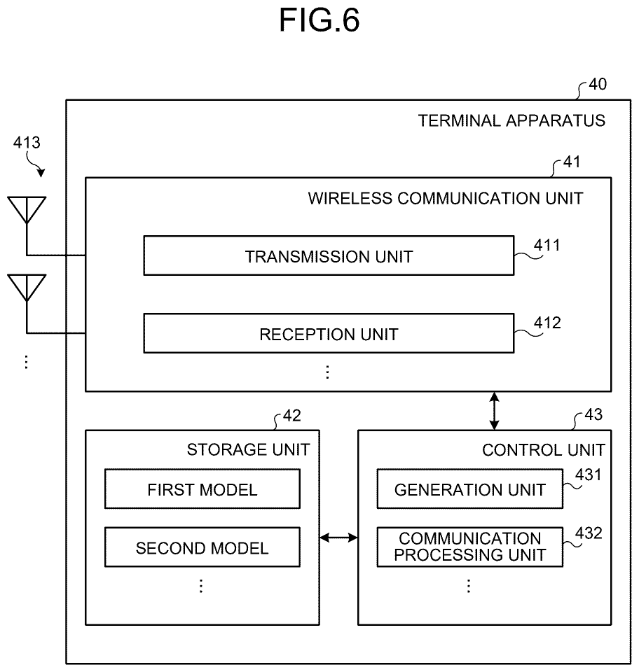

FIG. 6 is a diagram illustrating a configuration of the terminal apparatus 40 according to the present embodiment. The terminal apparatus 40 includes a wireless communication unit 41, a storage unit 42, and a control unit 33. The configuration illustrated in FIG. 6 is a functional configuration, and the hardware configuration may be different from this configuration. Furthermore, the functions of the terminal apparatus 40 may be implemented in a distributed manner in a plurality of physically separated configurations.

The wireless communication unit 41 is a signal processing unit for performing wireless communication with other wireless communication apparatuses (for example, the base station 20, the relay station 30, and another terminal apparatus 40). The wireless communication unit 41 is controlled by the control unit 43. The wireless communication unit 41 may support one or a plurality of radio access schemes. For example, the wireless communication unit 41 may support both NR and LTE. The wireless communication unit 41 may support W-CDMA, cdma2000, and the like in addition to NR and LTE. The wireless communication unit 41 may support an automatic retransmission technology such as Hybrid Automatic Repeat reQuest (HARQ).

The wireless communication unit 41 includes a transmission unit 411, a reception unit 412, and an antenna 413. The wireless communication unit 41 may include a plurality of the transmission units 411, a plurality of the reception units 412, and a plurality of the antennas 413. In a case where the wireless communication unit 41 supports a plurality of radio access schemes, individual portions of the wireless communication unit 41 may be configured separately for each of the radio access schemes. For example, the transmission unit 411 and the reception unit 412 may be individually configured depending on LTE or NR. The antenna 413 may include a plurality of antenna elements, for example, a plurality of patch antennas. The wireless communication unit 41 may have a beamforming function. The wireless communication unit 21 may have a polarization beamforming function using vertically polarized waves (V-polarized waves) and horizontally polarized waves (H-polarized waves).

The storage unit 42 is a readable/writable storage device such as DRAM, SRAM, flash memory, or a hard disk. The storage unit 42 functions as a storage means in the terminal apparatus 40. The storage unit 42 may store information of one or both of the first model and the second model. The learning model (the first model and/or the second model) stored in the terminal apparatus 40 may be similar to or different from the learning model stored in the base station or the relay station described above. The first model and the second model will be described below.

The control unit 43 is a controller that controls individual parts of the terminal apparatus 40. The control unit 43 controls the wireless communication unit to perform wireless communication with another wireless communication apparatus (for example, the base station 20, the relay station 30, or another terminal apparatus 40). The control unit 43 may be implemented by a processor such as a CPU or an MPU. For example, the control unit 23 is implemented by the processor executing various programs stored in the storage device inside the terminal apparatus 40 using RAM or the like as a work area. The control unit 43 may be implemented by an integrated circuit such as an ASIC or an FPGA. The CPU, MPU, ASIC, and FPGA can all be regarded as controllers. Furthermore, the control unit 43 may be implemented by a Graphics Processing Unit (GPU) in addition to or in place of the CPU.

The control unit 43 includes a generation unit 431 and a communication processing unit 432. Individual blocks (the generation unit 431 to the communication processing unit 432) constituting the control unit 43 are functional blocks individually indicating functions of the control unit 43. These functional blocks may be software blocks or hardware blocks. For example, each of the functional blocks described above may be one software module realized by software (including a microprogram) or one circuit block on a semiconductor chip (die). Needless to say, each of the functional blocks may be formed as one processor or one integrated circuit. Note that the control unit 43 may be configured in a functional unit different from the above-described functional block. The functional block may be configured by using any method.

The generation unit 431 generates various types of information to be transmitted to another communication apparatus. For example, the generation unit 431 uses the second model to generate the second information (for example, assistance information R) from the first information (for example, compressed information/feature information of the assistance information T).

The communication processing unit 432 transmits various types of information to another communication apparatus via the transmission unit 411 of the wireless communication unit 41. For example, the communication processing unit 432 transmits the fourth information used for generating the third information to another communication apparatus (for example, the base station 20). Furthermore, the communication processing unit 432 receives various types of information from another communication apparatus via the reception unit 412 of the wireless communication unit 41. For example, the communication processing unit 432 receives the first information from another communication apparatus (for example, the base station 20). Note that the communication processing unit 432 can be rephrased as a communication control unit. Furthermore, the communication processing unit 432 may be divided into a transmission processing unit (transmission control unit) and a reception processing unit (reception control unit).

In addition, the operations of the generation unit 431 and the communication processing unit 432 may be similar to the operations of the generation unit 231 of the base station 20 or the communication processing unit 232, respectively. Furthermore, the operations of the generation unit 431 and the communication processing unit 432 may be similar to the operations of the generation unit 331 of the relay station 30 or the communication processing unit 332, respectively. The operations of the generation unit 431 and the communication processing unit 432 will be described in detail below.

### 2-5. Learning Model

As described above, the storage unit 22 of the base station 20, the storage unit 32 of the relay station 30, and the storage unit 42 of the terminal apparatus 40 each store a learning model. Furthermore, as described above, the generation unit 231 of the base station 20, the generation unit 331 of the relay station 30, or the generation unit 431 of the terminal apparatus 40 each generates various types of information (first information or second information) using the learning model (first model or second model). The learning model in the present embodiment is, for example, a trained model for encoding or decoding.

The learning model is, for example, a machine learning model such as a neural network model. The neural network model includes an input layer, an intermediate layer (or a hidden layer), and an output layer, each including a plurality of nodes, the nodes being connected to each other via edges. Each layer has a function referred to as an activation function, and each edge is weighted. The learning model has one or a plurality of intermediate layers (or a hidden layer). In a case where the learning model is implemented as a neural network model, learning of the learning model includes, for example, setting the number of intermediate layers (or hidden layers), the number of nodes in each layer, the weight of each edge, or the like.

Here, the neural network model may be a model trained by deep learning. In this case, the neural network model may be a model in a form of a Deep Neural Network (DNN). The neural network model may be a model in a form referred to as a convolution neural network (CNN), a recurrent neural network (RNN), or long short-term memory (LSTM), for example. Needless to say, the neural network model is not limited to these forms of models.

Needless to say, the learning model is not limited to a neural network model. For example, the learning model may be a model based on reinforcement learning. In reinforcement learning, the model is trained through trial and error to take an action (setting) that maximizes value. In addition, the learning model may be a logistic regression model.

Note that the learning model may include a plurality of models. For example, the learning model may include a plurality of neural network models. More specifically, the learning model may include a plurality of neural network models selected from CNN, RNN, and LSTM, for example. In a case where the learning model includes a plurality of neural network models, the plurality of neural network models may be in a dependent relationship or a parallel relationship.

Note that the learning model can be rephrased as an artificial intelligence (AI) model, a machine learning (ML) model, or a trained model. In the following description, the learning model may be simply referred to as a model.

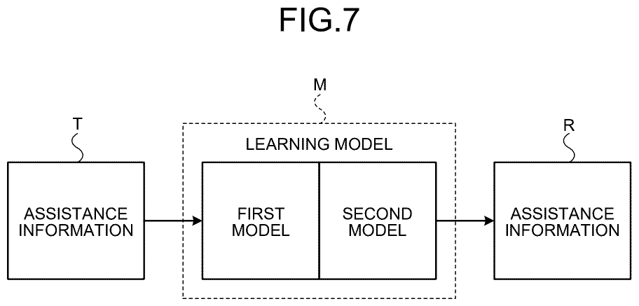

The storage unit 22 of the base station 20, the storage unit 32 of the relay station 30, and the storage unit 42 of the terminal apparatus 40 store a learning model (first model or second model) for encoding or decoding. The first model is a learning model for encoding, while the second model is a learning model for decoding. FIG. 7 is a diagram for illustrating the first model and the second model. As illustrated in FIG. 7, the first model and the second model each are a submodel of one learning model M. Note that a submodel can also be regarded as a type of learning model. Hereinafter, the learning model of the present embodiment will be described in detail.

The learning model M is, for example, a learning model (trained model) that has performed learning with the assistance information T as input data and the assistance information R as a ground truth label (training data). As described above, the assistance information is information necessary for the reception apparatus to perform processing related to wireless communication or information for assisting processing related to wireless communication, performed by the reception apparatus. For example, the assistance information is information (for example, control information) necessary for operations, such as uplink data transmission, sidelink transmission, unlicensed communication, and handover of the terminal apparatus 40. The assistance information R is information related to the assistance information T. The assistance information R may be information partially different from the assistance information T or may be information indicating the same information as the assistance information T.

When the base station 20 or the terminal apparatus 40 inputs the third information (for example, the assistance information T) to the first model of the learning model M, the first model outputs the first information (for example, compressed information/feature information of the assistance information T). In addition, when the base station 20 or the terminal apparatus 40 inputs the first information to the second model of the learning model M, the second model outputs the second information (for example, the assistance information R).

In this case, the learning model M may be a learning model that includes: an input layer that inputs third information (for example, the assistance information T); an output layer that outputs second information (for example, the assistance information R); a first element that belongs to any layer from the input layer to the output layer other than the output layer; and a second element having a value calculated based on the first element and the weight of the first element. The learning model M may be a learning model to cause a computer to function to output the second information from the output layer in accordance with the third information input to the input layer by performing an operation based on the first element and the weight of the first element (that is, a connection coefficient) using each element belonging to each layer other than the output layer as the first element onto the information input to the input layer.

Here, it is assumed that the learning model M is implemented by a neural network having one or a plurality of intermediate layers such as a DNN. In this case, for example, the first element included in the learning model corresponds to any node of the input layer or the intermediate layer. In addition, the second element corresponds to a node at a next stage which is a node to which a value is transmitted from a node corresponding to the first element. In addition, the weight of the first element corresponds to a connection coefficient being a weight considered for a value transmitted from the node corresponding to the first element to the node corresponding to the second element.

In addition, the machine learning model M is assumed to be implemented by a regression model expressed by “y=a1x1+a2*x2+ . . . +ai*xi”. In this case, for example, the first element included in the learning model M corresponds to input data (xi) such as x1, x2, etc. Furthermore, the weight of the first element corresponds to a coefficient ai corresponding to xi. Here, the regression model can be regarded as a simple perceptron having an input layer and an output layer. When each model is regarded as a simple perceptron, the first element can be regarded as any node included in the input layer, and the second element can be regarded as a node included in the output layer.

The base station 20 or the terminal apparatus 40 calculates information to be output using a model having any type of structure such as a neural network and a regression model. Specifically, the learning model M has a coefficient being set so as to output the second information (for example, assistance information R) in response to the input of the third information (for example, the assistance information T). For example, the base station 20 or the terminal apparatus 40 sets the coefficient based on similarity between the second information and a value obtained by inputting the third information to the learning model. The base station 20 or the terminal apparatus 40 generates the first information from the third information using such a submodel (first model) of the learning model M. Alternatively, the base station 20 or the terminal apparatus 40 generates the second information from the first information by using such a submodel (second model) of the learning model M.

The above example has described the model that outputs the second information in a case where the third information is input, as an example of the learning model M. However, the learning model M according to the embodiment may be a model generated based on a result obtained by repeating input and output of data to and from the learning model.

Furthermore, in a case where the base station 20 or the terminal apparatus 40 performs learning or generation of output information using a Generative Adversarial Network (GAN), the learning model may be a model constituting a part of the GAN.

Note that a training apparatus that training the learning model M may be the base station 20, the relay station 30, or the terminal apparatus 40. The training apparatus may be another information processing apparatus (for example, the management apparatus 10 or a server apparatus connected to the management apparatus 10 via a network). For example, it is assumed that the server apparatus trains the learning model M. In this case, the server apparatus trains the learning model M and stores the trained learning model M in the storage unit. More specifically, the server apparatus sets the connection coefficient of the learning model M such that the learning model outputs the second information (for example, assistance information R) when the third information (for example, the assistance information T) is input to the learning model M.

For example, the information processing apparatus (for example, the management apparatus 10, the base station 20, the relay station 30, the terminal apparatus 40, or the server apparatus) inputs the third information to the node of the input layer included in the learning model M, allows the data to propagate to the output layer of the learning model M through each intermediate layer so as to cause the learning model M to output the second information. Subsequently, the server apparatus corrects the connection coefficient of the learning model M based on a difference between the value actually output by the learning model M and the value defined as the ground truth label (training data). At this time, the server apparatus may correct the connection coefficient using a method such as back propagation. At this time, the server apparatus may correct the connection coefficient based on a cosine similarity between a vector indicating the input value and a vector indicating the value actually output by the learning model.

The learning may use any learning algorithm. For example, the information processing apparatus may train the learning model by using a learning algorithm such as a neural network, a support vector machine, clustering, reinforcement learning, random forest, or a decision tree.

Although the method of generating the learning model M has been described above, the information processing apparatus can separately train the first model and the second model. For example, the information processing apparatus may train the first model using the third information (for example, the assistance information T) as input data and the first information (for example, compressed information/feature information of the assistance information T) as training data (ground truth label). Furthermore, the information processing apparatus may train the second model using the first information (for example, compressed information/feature information of the assistance information T) as input data and the second information (for example, assistance information R) as training data (ground truth label).

Furthermore, the learning algorithm used in the present embodiment may be used for the training performed by a single information processing apparatus (for example, the management apparatus 10, the base station 20, the relay station 30, the terminal apparatus 40, or the server apparatus) alone, or may be used for the collaborative training performed by a plurality of information processing apparatuses (for example, a plurality of apparatuses selected from the management apparatus 10, the base station 20, the relay station 30, the terminal apparatus 40, and the server apparatus). Here, an example of a learning algorithm used for the collaborative training performed by the plurality of information processing apparatuses is federated learning.

### 3. Operation of Communication System

The configuration of the communication system 1 has been described above. Next, the operation of the communication system 1 having such a configuration will be described.

### 3-1. Overall Picture of Operation of Communication System

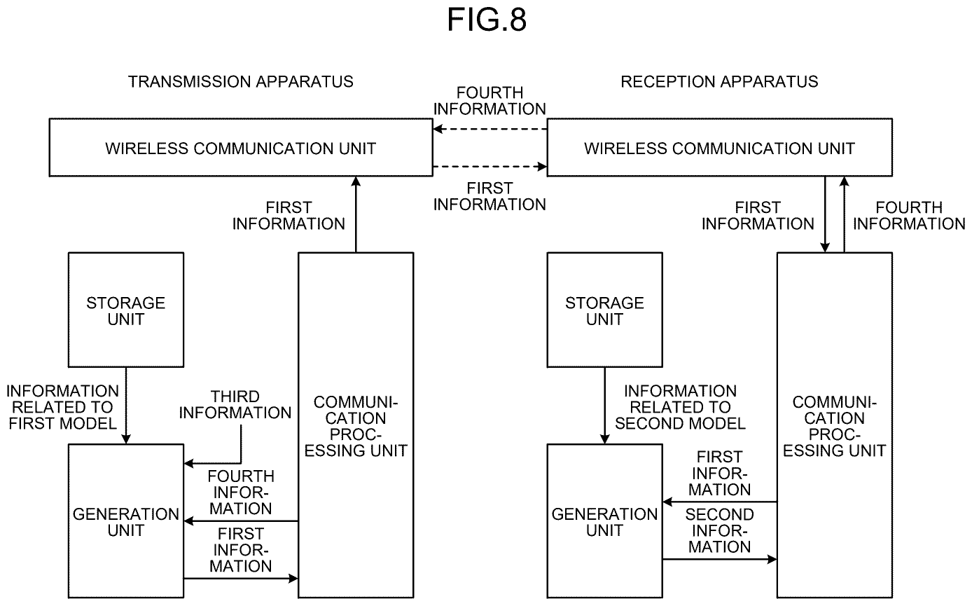

FIG. 8 is a diagram illustrating an overall picture of the operation of the communication system 1. As described above, transmission apparatus (for example, the base station 20) generates first information (for example, compressed information/feature information of the assistance information T) from the third information (for example, the assistance information T) by using the first model. The generation of the third information may use fourth information received from another communication apparatus (for example, the reception apparatus). The transmission apparatus transmits the generated first information to the reception apparatus (for example, the terminal apparatus 40). The reception apparatus receives the first information generated by using the first model from the transmission apparatus. Subsequently, the reception apparatus generates the second information (for example, the assistance information R) from the first information by using the second model corresponding to the first model. Subsequently, the reception apparatus executes processing related to wireless communication by using the second information.

The overall picture of the operation of the communication system 1 has been described above. Now, the operation of the communication system 1 will be described in detail below.

In the following description, the first information is assumed to be compressed information/feature information of the assistance information T as an example. However, the first information is not limited to the compressed information/feature information of the assistance information T. The first information may be compressed information/feature information of information other than the assistance information T. In the following description, the first information may be referred to as transmission data or reception data.

In the following description, the third information and the second information are assumed to be assistance information as an example, but the third information and the second information are not limited to the assistance information. The third information and the second information may be information (for example, content data) irrelevant to the processing related to the wireless communication. In addition, any information (for example, control information/user data) can be set as the third information and the second information.

In the following description, the transmission apparatus is represented by the base station 20 and the reception apparatus is represented by the terminal apparatus 40, but the transmission apparatus and the reception apparatus are not limited to this example. Here, the transmission apparatus may be the relay station 30 or the terminal apparatus 40. The reception apparatus may be the base station 20 or the relay station 30. Similarly, the description of the terminal apparatus 40 appearing in the following description can be replaced with a description indicating another communication apparatus (for example, the base station 20 or the relay station 30) as appropriate.

### 3-2. Assistance Information

First, assistance information serving as notification target data will be described.

As described above, the base station 20 generates the first information from the assistance information T using the first model. Subsequently, the base station 20 generates the first information for the terminal apparatus 40. The terminal apparatus 40 generates the assistance information R from the first information by using the second model.

Here, the assistance information (assistance information T and assistance information R) is information necessary for the terminal apparatus 40 to perform processing related to wireless communication or information for assisting processing related to wireless communication of the terminal apparatus 40. For example, the assistance information is information (for example, control information) necessary for operations, such as uplink data transmission, sidelink transmission, unlicensed communication, and handover of the terminal apparatus 40. The assistance information may be information necessary for the terminal apparatus 40 to perform data reception (for example, downlink data reception and sidelink reception). The assistance information R is information related to the assistance information T. At this time, the assistance information R may be information partially different from the assistance information T or may be information indicating the same information as the assistance information T.

For example, it is assumed that the assistance information R is information having data different from data of the assistance information T. In this case, the assistance information R may be information in which a part or all of the assistance information T is replaced with another information, or may be information from which a part of the assistance information T is removed. For example, the assistance information R may be information in which some or all of the assistance information T is replaced/integrated with another information having same effects, or may be information from which a redundant portion of the assistance information T has been removed.

In a case where the assistance information T and the assistance information R have data of same effects, the data of the assistance information T and the assistance information R do not necessarily have to completely match each other. For example, the assistance information T and the assistance information R may be information semantically the same with different expressions (for example, the data format). When the assistance information R corresponds to the assistance information T, the assistance information T and the assistance information R can be regarded as semantically the same information.

A specific example of the assistance information (assistance information T and/or assistance information R) can be data illustrated in the following (A1) to (A8).
(A1) Information related to channel state (for example, the channel state Raw data or the channel state eigenvalue information)
(A2) Information based on a predetermined feedback table (for example, index information based on the feedback table)
(A3) Reception quality data (including information of a cell currently connected or an adjacent cell) such as Reference Signal Received Power (RSRP) and Reference Signal Received Quality (RSRQ)
(A4) Position Information of Base Station 20 or Terminal Apparatus 40
(A5) Radio wave propagation delay information
(A6) Status information (for example, position information or reflectance) of the relay station 30 (or the reflector) such as a repeater or a large intelligent surface (LSI).
(A7) Orbital information of satellite station and position information of terrestrial station
(A8) Information related to frequency use status

The base station 20 and the terminal apparatus 40 can use a part or all of the above data as assistance information. Naturally, the assistance information is not limited to the above example. Any information (for example, control information other than the above and/or user data other than the above) used by the transmission apparatus (terminal apparatus 40) in processing related to wireless communication can be used as assistance information.

In a case where it is necessary to provide information from the terminal apparatus 40 for the base station 20 to generate the assistance information T, the terminal apparatus 40 may transmit a predetermined signal (fourth information) to the base station 20. The base station 20 generates the assistance information T based on the signal (fourth information) received from the terminal apparatus 40.

Here, the predetermined signal (fourth information) may be one or a plurality of signals selected from the following (B1) to (B7). Naturally, the fourth information may be a signal (or information) other than the signals described below.
(B1) Channel state information reference signal (CSI-RS)
(B2) Sounding Reference Signal (SRS)
(B3) Demodulation reference signal (DM-RS)
(B4) Positioning reference signal (PRS)
(B5) Phase-tracking reference signal (PT-RS)
(B6) Preamble
(B7) Uplink reference signal (for example, the uplink reference signal limited to the Configured Grant resource)

### 3-3. Learning Model

Next, learning models (the first model and the second model) will be described.

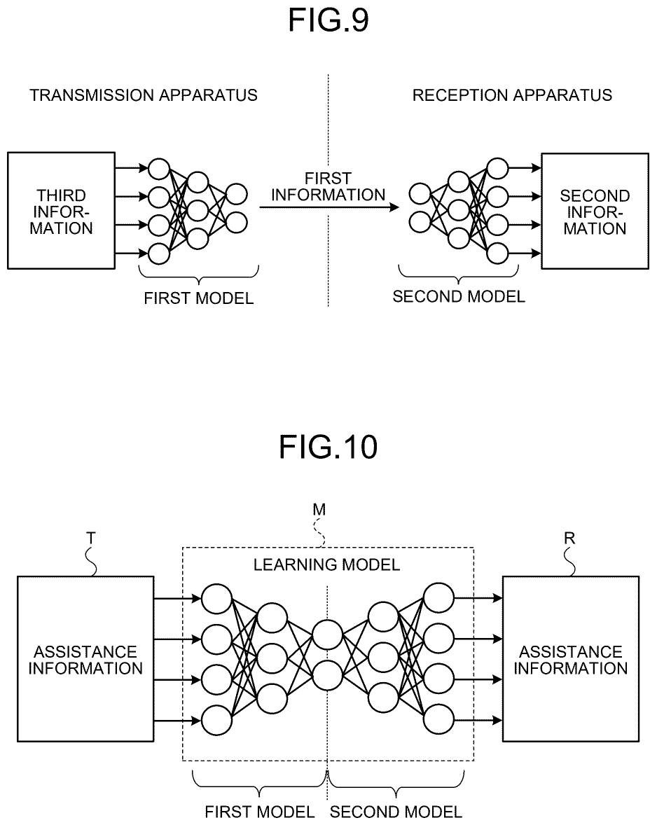

FIG. 9 is a diagram for illustrating the first model and the second model. As described above, the base station 20 uses the first model to generate the first information from the third information (for example, the assistance information T). The base station 20 transmits the first information (for example, compressed information/feature information of the assistance information T) generated using the first model, to the terminal apparatus 40. The terminal apparatus 40 generates the second information (for example, assistance information R) from the first information by using the second model.

The first model and the second model are each a submodel of the learning model M. Here, it is assumed that the learning model M is a neural network. At this time, the first model may be a model including the first half (for example, a first half of the input layer and an intermediate layer) of the learning model M. Furthermore, the second model may be a model including the second half (for example, the second half of the intermediate layer and an output layer) of the learning model M. A submodel can also be regarded as a type of learning model. The learning model M may be an encoder-decoder model. At this time, the first model may be an encoder, and the second model may be a decoder. The encoder and the decoder can also be regarded as submodels of the learning model M.

FIG. 10 is a diagram illustrating an example of the learning model M. Examples of the learning model M includes a trained model in which the number of nodes in the intermediate layer is smaller than the number of nodes in the input layer and the number of nodes in the output layer, and the number of nodes in the input layer and the number of nodes in the output layer are equal to each other. In the example of FIG. 10, data input to the input layer is the assistance information T, and data output from the output layer is the assistance information R. In the case of the learning model M illustrated in FIG. 10, information compression (or feature extraction) is performed once in the intermediate layer. Therefore, there may be a difference between the data (assistance information T) input to the input layer and the data (assistance information R) output from the output layer.

In the example of FIG. 10, by dividing the learning model M by nodes in the intermediate layer, the learning model M is separated into the first model used by the transmission apparatus (base station 20) and the second model used by the reception apparatus (terminal apparatus 40). In the example of FIG. 10, the submodel on the input layer side of the learning model M is the first model, and the submodel on the output layer side of the learning model M is the second model.

The learning model M illustrated in FIG. 10 is a learning model including an input layer having four nodes and an output layer having four nodes, and including an intermediate layer having two nodes at minimum. The learning model M is divided at a portion where the number of nodes is minimum (the second layer of the intermediate layer in the example of FIG. 10). The learning model M is divided by the nodes of the intermediate layer. For example, the learning model M is divided at a portion where the number of nodes in the intermediate layer is minimum (the second layer of the intermediate layer in the example of FIG. 10). With this division, the learning model M is divided into the first model used by the transmission apparatus (base station 20) and the second model used by the reception apparatus (terminal apparatus 40). At this time, the data (first information) output from the first model is information obtained by compressing (or performing feature extraction from) the assistance information T. That is, the first model is a learning model configured such that the data amount of the first information to be output is smaller than the data amount of the assistance information T (third information) to be input.

The base station 20 and the terminal apparatus 40 perform processing related to wireless communication (for example, generation of first information or second information) using such a learning model (the first model or the second model).

Note that processing related to wireless communication performed using the learning model (first model or second model) is not limited to generation of the first information or the second information. The processing related to the wireless communication may include transmission signal processing or reception signal processing. For example, the base station 20 and the terminal apparatus 40 may apply a learning model (first model or second model) as part of bit sequence signal processing and/or complex signal point signal processing. At this time, the learning model (first model or second model) may be a signal processing model that performs a part of conventional signal processing, or may be a signal processing model that performs a plurality of functions among the conventional signal processing functions.

Here, the bit sequence signal processing may include one or a plurality of types of processing selected from the following (C1) to (C5). Naturally, the bit sequence signal processing is not limited to the following processing.
(C1) Cyclic Redundancy Check Addition
(C2) Error correction
(C3) Rate matching
(C4) Scrambling
(C5) Interleaving

Furthermore, the complex signal point signal processing may include one or a plurality of types of processing selected from the following (D1) to (D6). Naturally, the complex signal point signal processing is not limited to the following processing.
(D1) Modulation processing (for example, Quadrature Phase Shift Keying (QPSK) and Quadrature Amplitude Modulation (QAM))/demodulation processing
(D2) Multi-antenna processing
(D3) Precoding processing
(D4) Resource mapping processing
(D5) Transform precoding processing including Discrete Fourier Transformation (DFT)/Inverse Discrete Fourier Transform (IDFT) processing
(D6) Orthogonal Frequency Division Multiplexing (OFDM) signal processing

Note that the learning model (first model or second model) may be a signal processing model including both functions of bit sequence signal processing and complex signal point signal processing.

Furthermore, the learning model (first model or second model) may be configured to execute processing based on a new signal processing scheme in which a function is newly added to a conventional signal processing scheme. At this time, the new signal processing scheme may be a signal processing scheme obtained by adding a data compression or data decoding function to the conventional signal processing scheme. Furthermore, the new signal processing scheme may be a signal processing scheme in which an operation parameter inferred with a channel state or the like as input information is input to the conventional signal processing scheme.

### 3-4. Generation of Data Using Learning Model

Next, generation of data using the learning model (first model or second model) will be described.

The base station 20 generates the first information from the assistance information T using the first model. Subsequently, the terminal apparatus 40 generates the assistance information R from the first information by using the second model. As described above, the second model is a learning model corresponding to the first model.

Note that one communication apparatus of the base station 20 and the terminal apparatus 40 may transmit information related to the learning model (learning model M/first model/second model) to the other communication apparatus. For example, the base station 20 may transmit information related to the second model to the terminal apparatus 40. The terminal apparatus 40 may receive information related to the second model from the base station 20.

For example, one communication apparatus of the base station 20 and the terminal apparatus 40 may transmit information to be a base of learning, as the information related to the learning model. Here, the information to be the base of learning may include one or a plurality of pieces of information selected from the following (E1) to (E4). Naturally, the information to be the base of learning is not limited to the following information. Note that the “base of learning” may be rephrased as another term such as an “initial value of learning”.
(E1) Type of learning model M (alternatively, the first model/the second model)
(E2) Basic information at the start of learning (for example, the number of nodes in the input layer, the number of nodes in the output layer, the network node layer configuration information, and weight information)
(E3) Layer information for learning
(E4) Data used for learning

Note that one communication apparatus of the base station 20 and the terminal apparatus 40 may transmit information of a trained model (learning model M/first model/second model) as the information related to the learning model. For example, the base station 20 may transmit information of the trained second model to the terminal apparatus 40. The terminal apparatus 40 may generate the assistance information R from the first information by using the trained model (second model) provided from the base station 20.

### 3-5. Switching of Signal Processing

As described above, the processing related to the wireless communication performed using the learning model (first model or second model) may be transmission signal processing or reception signal processing. Here, the base station 20 and the terminal apparatus 40 may be configured to be switchable between a first signal processing scheme using the learning model and a second signal processing scheme not using the learning model.

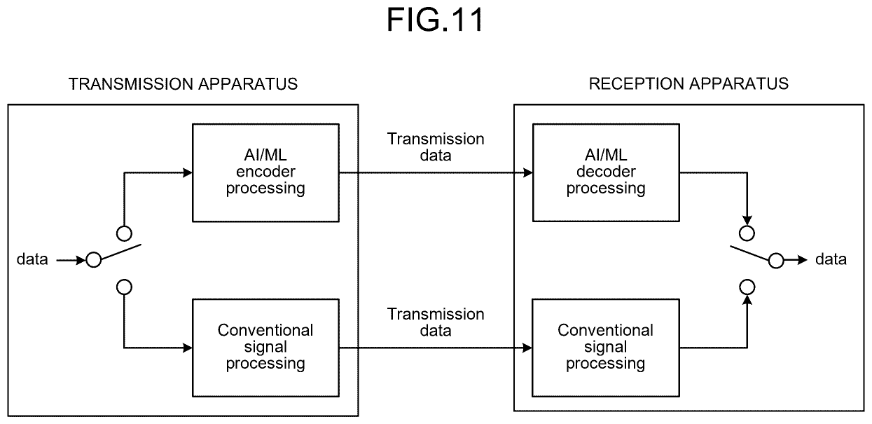

FIG. 11 is a diagram illustrating a transmission apparatus and a reception apparatus that perform communication by switching between a first signal processing scheme and a second signal processing scheme. For example, the base station 20 and the terminal apparatus 40 define the transmission signal processing scheme or the reception signal processing scheme using the learning model (first model or second model) as the first signal processing scheme, and define the transmission signal processing scheme or the reception signal processing scheme not using the learning model (first model or second model) as the second signal processing scheme. In the example of FIG. 11, AI/ML encoder processing is transmission signal processing using the first signal processing scheme, and AI/ML decoder processing is reception signal processing using the first signal processing scheme. In the example of FIG. 11, conventional signal processing is transmission signal processing/reception signal processing using the second signal processing scheme.

The base station 20 and the terminal apparatus 40 may switch between the first signal processing scheme and the second signal processing in accordance with a predetermined condition.

For example, one communication apparatus of the base station 20 and the terminal apparatus 40 may receive the information related to the application of the learning model (the first model or the second model) from the other communication apparatus of the base station 20 and the terminal apparatus 40. For example, the terminal apparatus 40 may receive, from the base station 20, information related to application of processing of generating the second information by using the second model. At this time, the information related to the application of the learning model may be information notification of which is semi-statically provided from another communication apparatus, or may be information notification of which is dynamically provided from another communication apparatus. Subsequently, the terminal apparatus 40 may switch between the first signal processing scheme and the second signal processing based on the information related to the application of the learning model.

Assumable predetermined conditions include any one of the following (F1) to (F3). In the following examples, the conditions under which the “first signal processing scheme” is applied and the conditions under which the “second signal processing scheme” is applied may be reversed. In addition, the predetermined condition is not limited to the following example.
(F1) Switching based on information related to whether or not to apply learning model to signal processing
(F2) Switching based on explicit notification
(F3) Switching based on implicit notification

Hereinafter, (F1) to (F3) will be described in detail.

(F1) Information Related to Whether or Not to Apply Learning Model to Signal Processing

The base station 20 notifies the terminal apparatus 40 of information related to whether or not to apply the learning model. The terminal apparatus 40 determines whether to use one of the first signal processing scheme and the second signal processing scheme based on the information related to whether or not to apply the learning model.

At this time, the base station 20 may explicitly notify the terminal apparatus 40 of semi-static information or dynamic information related to whether or not the learning model is applied. When application of the learning model is determined by the explicit notification, the terminal apparatus 40 processes the transmission signal using the first signal processing scheme. When non-application of the learning model is determined by the explicit notification, the terminal apparatus 40 processes the transmission signal using the second signal processing scheme.

In addition, the base station 20 may implicitly notify the terminal apparatus 40 of semi-static information or dynamic information related to whether or not the learning model is applied. When application of the learning model is determined by the implicit notification, the terminal apparatus 40 processes the transmission signal using the first signal processing scheme. When non-application of the learning model is determined by the implicit notification, the terminal apparatus 40 processes the transmission signal using the second signal processing scheme.

The terminal apparatus 40 may notify the base station 20 of capability information related to the application of the learning model to the signal processing as the information related to whether to apply the learning model. In a case where the terminal apparatus 40 has no capability of applying the learning model to signal processing, the terminal apparatus 40 and the base station 20 process the signal using the second signal processing scheme. In a case where the terminal apparatus 40 has a capability of applying the learning model to signal processing, the terminal apparatus 40 and the base station 20 process the signal using the first signal processing scheme. In a case where the terminal apparatus 40 has a capability of applying the learning model to signal processing, the terminal apparatus 40 and the base station 20 may determine whether to use the first signal processing scheme or the second signal processing scheme based on another condition.

### (F2) Switching Based on Explicit Notification

The base station 20 notifies the terminal apparatus 40 of the switching of the signal processing scheme (the first signal processing scheme and the second signal processing scheme) through explicit control information related to the application of the learning model to signal processing. Examples of the switching notification by the explicit control information include the following (a1) to (a4).
(a1) Switching notification by system information
(a2) Switching notification by RRC signaling
(a3) Switching notification by MAC CE
(a4) Switching notification by DCI

Note that the terminal apparatus 40 may explicitly notify the base station 20 of the switching of the signal processing scheme (the first signal processing scheme and the second signal processing scheme).

### (F3) Switching Based on Implicit Notification

The base station 20 may implicitly notify the terminal apparatus 40 of switching of the signal processing scheme (the first signal processing scheme and the second signal processing scheme). In addition, the terminal apparatus 40 may implicitly notify the base station 20 of the switching of the signal processing scheme (the first signal processing scheme and the second signal processing scheme). Examples of the implicit switching notification include the following (b1) to (b19). Note that the following implicit notification may be combined with the above-described explicit notification. In the following description, the base station 20 and/or the terminal apparatus 40 may be simply referred to as a communication apparatus.

### (b1) Switching by Type of Assistance Information

The communication apparatus may switch the signal processing scheme depending on the type of assistance information. Assumable assistance information include (A1) to (A8) described above.

### (b2) Switching by Control Information Content

The communication apparatus may switch the signal processing scheme by the control information content (for example, Downlink Control Information (DCI) content or Uplink Control Information (UCI) content). Examples of the control information content include the following.
Reference signal configuration information (the reference signal includes DMRS, CSI-RS, SRS, and PT-RS, for example.)
Random access configuration information
Modulation and Coding Scheme (MCS) information
Precoding Matrix information
PUCCH Configuration information
Layer mapping information
Channel Quality Information (CQI) information
Precoding Matrix Indicator (PMI) information
Layer Indicator (LI) information
Rank Indicator (RI) information

The communication apparatus may switch the signal processing scheme (the first signal processing scheme and the second signal processing scheme) in accordance with the control information content to be transmitted. For example, the communication apparatus uses the first signal processing scheme when transmitting the PMI, and uses the second signal processing scheme when transmitting the RI. Note that the above is merely an example. Which signal processing scheme is used for which control information content is not limited to the above. The combination of the control information content and the signal processing scheme may be determined in advance, or may be dynamically determined by signaling or the like. That is, the communication apparatus may selectively use whether or not to apply the learning model to the signal processing in accordance with the DCI content or the UCI content.

### (b3) Switching by Control Information Format

The communication apparatus may switch the signal processing scheme in accordance with the control information format (for example, the DCI format or the UCI format).

For example, the communication apparatus may use the first signal processing scheme when having received DCI format 0_0, and may use the second signal processing scheme when having received DCI format 0_1. In addition, the communication apparatus may use the first signal processing scheme when having received UCI format 0, and may use the second signal processing scheme when having received UCI format 1. In addition, the communication apparatus may use the first signal processing scheme for the control information format with a large amount of information, and may use the second signal processing scheme for the control information format with a small amount of information.

### (b4) Switching by Channels

The communication apparatus may switch the signal processing scheme in accordance with the channel (for example, a data channel or a control channel). Here, the data channel or the control channel may be any of the following, for example.

### Logical Channel

Examples of the logical channel include a Broadcast Control Channel (BCCH), a Paging Control Channel (PCCH), a Common Control Channel (CCCH), a Dedicated Control Channel (DCCH), and a Dedicated Traffic Channel (DTCH).

### Transport Channel

Examples of the transport channel include a broadcast channel (BCH), a downlink shared channel (DL-SCH), an uplink shared channel (UL-SCH), and a paging channel (PCH).

### Physical Channel

Examples of the physical channel include a Physical Broadcast Channel (PBCH), a Physical Downlink Control Channel (PDCCH), a Physical Uplink Control Channel (PUCCH), a Physical Sidelink Control Channel (PSCCH), a Physical Downlink Shared Channel (PDSCH), a Physical Uplink Shared Channel (PUSCH), a Physical Sidelink Shared Channel (PSSCH), and a Physical Random Access Channel (PRACH).

For example, the communication apparatus may use the first signal processing scheme in a control channel (for example, PUCCH), and may use the second signal processing scheme in a data channel (for example, PUSCH). In addition, the communication apparatus may apply the first signal processing scheme only to a specific channel such as a PUCCH, and may avoid using the first signal processing scheme in other channels.

### (b5) Switching by Connection State

The communication apparatus may switch the signal processing scheme in accordance with the connection state.

For example, the communication apparatus may use the second signal processing scheme at establishment of a connection (for example, at the time of registration processing, at the time of PDU session establishment processing, or at the time of initial connection), and may use the first signal processing scheme after establishment of the connection.

For example, the communication apparatus may switch the signal processing scheme depending on the RRC Status. For example, the communication apparatus may use the second signal processing scheme in RRC Idle or RRC Inactive, and use the first signal processing scheme in RRC Connected.

For example, the communication apparatus selects the time of application such that the first signal processing is not to be applied until the connection is established, and the first signal processing scheme is to be used after the establishment of the connection, making it possible to enhance the stability before the connection.

### (b6) Switching by Network Slice

The communication apparatus may switch the signal processing scheme in accordance with network slices. For example, the communication apparatus may use a first signal processing scheme in a first network slice, and may use a second signal processing scheme in a second network slice.

Here, the communication apparatus may determine the network slice by an identifier referred to as Single-Network Slice Selection Assistance Information (S-NSSAI). In this case, the communication apparatus may switch the signal processing scheme in accordance with the S-NSSAI.

For example, using the first signal processing scheme in a network slice requiring relatively large capacity communication, the communication apparatus improves frequency utilization efficiency. On the other hand, in other network slices, the communication apparatus may use a conventional signal processing scheme (second signal processing scheme) as the signal processing scheme.

### (b7) Switching by Quality of Service (QoS)

The communication apparatus may switch the signal processing scheme in accordance with QoS information such as 5G QoS Identifier (5QI). For example, using the first signal processing scheme in QoS packets requiring relatively large capacity communication, the communication apparatus improves frequency utilization efficiency. On the other hand, in other network slices, the communication apparatus may use a conventional signal processing scheme (second signal processing scheme).

### (b8) Switching by AI Processing Capability

The communication apparatus may switch the signal processing scheme in accordance with whether or not the communication apparatus itself and/or the communication partner have an AI processing capability. For example, the communication apparatus may use the second signal processing scheme when the communication apparatus and/or the communication partner have no AI processing capability, and may use the first signal processing scheme when the communication apparatus and/or the communication partner have the AI processing capability.

### (b9) Switching by Handover Procedure

The communication apparatus may switch the signal processing scheme in accordance with a handover procedure. For example, the communication apparatus may use the second signal processing scheme during the handover procedure, and use the first signal processing scheme for the occasion other than the handover procedure. For example, the terminal apparatus 40 does not use the first signal processing scheme during a handover procedure (until connection with the target base station 20 is established), and applies the first signal processing after establishment of the handover.

(b10) Switching According to Learning Situation

The communication apparatus may switch the signal processing scheme in accordance with the learning situation of the learning model (learning model M/first model/second model). For example, the communication apparatus may use the second signal processing scheme in a situation before learning is performed, and use the first signal processing scheme when learning is completed.

(b11) Switching by Subcarrier Spacing

The communication apparatus may switch a signal processing scheme in accordance with subcarrier spacing of a signal to be transmitted. For example, the communication apparatus may use the first signal processing scheme when the subcarrier spacing is 15 kHz, and use the second signal processing scheme when the subcarrier spacing is other than 15 kHz.

(b12) Switching by Transmission Method

The communication apparatus may switch the signal processing scheme in accordance with the data transmission scheme. For example, the communication apparatus may switch the signal processing scheme depending on whether the data transmission is collision-based transmission or non-collision-based transmission. For example, the communication apparatus may use the second signal processing scheme when the data transmission is a collision-based transmission, and use the first signal processing scheme when the data transmission is a non-collision-based transmission.

Here, the collision-based transmission represents data transmission that collides with or is likely to collide with other data transmission. Examples of the collision-based transmission include Configured Grant transmission and Non-Orthogonal Multiple Access (NOMA) transmission. For example, Non-Orthogonal Multiple Access (NOMA) data transmissions are collision-based data transmissions because they collide, on orthogonal axes, with other data transmissions superimposed on non-orthogonal axes.

(b13) Switching Depending on Whether or Not to Perform NOMA Signal Processing

The communication apparatus may switch the signal processing scheme in accordance with whether or not to perform non-orthogonal multiple access (NOMA) signal processing. For example, the communication apparatus may use the second signal processing scheme when performing non-orthogonal multiple access signal processing, and may use the first signal processing scheme when performing orthogonal multi-access signal processing.

Here, the non-orthogonal multiple access signal processing may include processing of multiple layer transmission by Multi-Input Multi-Output (MIMO) transmission. Furthermore, the non-orthogonal multiple access signal processing may include Multi-User MIMO (MU-MIMO) processing.

(b14) Switching by RNTI Scrambling Type of DCI

The communication apparatus may switch the signal processing scheme in accordance with a Radio Network Temporary Identifier (RNTI) scrambling type of the DCI. For example, the communication apparatus may use the first signal processing scheme when the DCI is scrambled with a first RNTI, and may use the second signal processing scheme when the DCI is scrambled with a second RNTI.

(b15) Switching by Resource

The communication apparatus may switch the signal processing scheme in accordance with a resource (frequency resource and/or time resource) used for communication. For example, the communication apparatus may switch the signal processing scheme depending on whether the resource used for communication is a predetermined resource (a predetermined frequency resource and/or a predetermined time resource).

For example, the communication apparatus may use the first signal processing scheme when a band width part (BWP) used for communication is a predetermined BWP, and may use the second signal processing scheme in other cases. In addition, the communication apparatus may use the first signal processing scheme in a case where the resource pool used for communication is a predetermined resource pool, and may use the second signal processing scheme in other cases. In addition, the communication apparatus may use the second signal processing scheme when transmitting data on a semi-statically configured resource, and may use the first signal processing scheme when transmitting data on a dynamically configured resource.

(b16) Switching by Frequency Band

The communication apparatus may switch the signal processing scheme in accordance with the frequency band used for communication. For example, the communication apparatus uses the second signal processing scheme in Frequency Range 1 (FR1), and uses the first signal processing scheme in Frequency Range 2 (FR2). Furthermore, the communication apparatus may apply the second signal processing scheme in a predetermined band or less, and use the first signal processing scheme in other bands.

(b17) Switching by Number of Symbols

The communication apparatus may switch the signal processing scheme in accordance with the number of symbols included in one slot. For example, the communication apparatus may use the first signal processing scheme when the number of symbols is greater than N symbols, and use the second signal processing scheme when the number of symbols is less than N symbols.

(b18) Switching by Transmission Method

The communication apparatus may switch the signal processing scheme in accordance with the data transmission scheme. For example, the communication apparatus may switch the signal processing scheme depending on whether the data transmission is the Dynamic grant transmission or the Configured grant transmission. For example, the communication apparatus may apply the second signal processing scheme when transmitting data on a semi-statically configured transmission resource (Configured grant), and may use the first signal processing scheme when transmitting data on a dynamically configured transmission resource (Dynamic grant).

(b19) Switching by RACH Procedure

The communication apparatus may switch the signal processing scheme in accordance with a RACH procedure. For example, the communication apparatus may use the second signal processing scheme in 2-step RACH and use the first signal processing scheme in 4-step RACH.

(b20) Switching by Timer

The communication apparatus may switch the signal processing scheme in accordance with a timer. For example, the communication apparatus may use the first signal processing scheme when the timer is in operation, and use a second signal processing scheme when the timer stops operation.

In the switching of the signal processing scheme, the operation of switching from the first signal processing scheme to the second signal processing scheme may be referred to as fallback.

### 3-6. Application to Configured Grant Transmission

The present embodiment may be used in Configured Grant transmission. Hereinafter, the operation of the communication system 1 according to the present embodiment will be described in detail using Configured Grant transmission as an example.

### 3-6-1. Configured Grant Transmission

The Configured Grant transmission indicates that the communication apparatus does not receive dynamic resource allocation (Grant) from another communication apparatus, and the communication apparatus performs transmission using an appropriate resource from available frequency and time resources instructed in advance from another communication apparatus. That is, the Configured Grant transmission indicates that data transmission is performed without including a grant in Downlink Control Information (DCI). The Configured Grant transmission is also referred to as Data transmission without grant, Grant-free, Semi-persistent Scheduling, or the like.

Before describing the operation of the communication system 1 of the present embodiment the Configured Grant transmission will be described below.

The base station 20 transmits a semi-statically configured uplink transmission grant (Configured Grant) to the terminal apparatus 40.

### (1) Control Information Required for Uplink Transmission

In the Configured grant transmission, one or more of the following information may be set from the base station 20 to the terminal apparatus 40. Note that the base station 20 may notify the terminal apparatus 40 of not only the following information but also control information required for uplink transmission.
Bandwidth part indicator
Frequency domain resource assignment
Time domain resource assignment
VRB-to-PRB mapping
Rate matching indicator
Modulation and coding scheme
New data indicator (NDI)
Redundancy version
HARQ process number
Downlink assignment index
Antenna port(s) and number of layers
CBG transmission information (CBGTI)
CBG flushing out information (CBGFI)
Timing Advance
Repetition number
Resource pool information

### (2) Setting Pattern of Configured Grant

Examples of the setting pattern of Configured grant include the following patterns.

### Setting Pattern 1

One example of assumable setting patterns is a pattern in which the base station 20 sets all the control information necessary for the uplink transmission to the terminal apparatus 40. In this case, the base station 20 sets one or a plurality of Configured Grants for the terminal apparatus 40. When setting a plurality of Configured grants, different control information is set in each of the plurality of Configured grants. The terminal apparatus 40 selects an appropriate Configured grant from one or a plurality of Configured grants and performs uplink transmission.

### Setting Pattern 2

Assumable examples of the setting pattern include a pattern in which the base station 20 sets only some parameters of the control information necessary for the uplink transmission to the terminal apparatus 40. In this case, parameters other than the parameters set by the base station 20 are to be determined by the terminal apparatus 40. In the present embodiment, the terminal apparatus 40 may determine the parameter based on the assistance information received from the base station 20.

The terminal apparatus 40 notifies the base station 20 of the determined parameter. At this time, the terminal apparatus 40 may notify the base station 20 of the parameter based on notification means (notification means of uplink transmission parameters) to be described below. Alternatively, the terminal apparatus 40 may check whether there is no problem in using the determined parameter for uplink transmission, for example, by transmitting the determined parameter to the base station 20. In this case, the terminal apparatus 40 may perform the uplink transmission after receiving the confirmation result from the base station 20 without immediately performing the uplink transmission.

### Setting Pattern 3

Assumable examples of the setting pattern include a pattern in which the base station 20 sets only resource pool information of the control information necessary for the uplink transmission to the terminal apparatus 40. In this case, the terminal apparatus 40 determines the parameter by using the resource in the resource pool, and implements uplink transmission.

The terminal apparatus 40 notifies the base station 20 of the determined parameter. At this time, the terminal apparatus 40 may notify the base station 20 of the parameter based on notification means (notification means of uplink transmission parameters) to be described below. Alternatively, the terminal apparatus 40 may check whether there is no problem in using the determined parameter for uplink transmission, for example, by transmitting the determined parameter to the base station 20. In this case, the terminal apparatus 40 may perform the uplink transmission after receiving the confirmation result from the base station 20 without immediately performing the uplink transmission.

### (3) Uplink Transmission Parameter Notification Means

Assumable uplink transmission parameter notification means are as follows.

### Notification Means 1

The communication apparatus (the base station 20 and/or the terminal apparatus 40) transmits the uplink transmission parameter by a predetermined resource. For example, the communication apparatus may transmit a parameter in a resource of a Configured grant used for uplink transmission. Alternatively, the communication apparatus may transmit the parameter in the Configured grant resource for uplink transmission parameter transmission.

### Notification Means 2

The communication apparatus (the base station 20 and/or the terminal apparatus 40) associates the uplink transmission parameter with the parameter of the reference signal.

For example, the base station 20 sets an uplink transmission parameter set selectable by the terminal apparatus 40 in the terminal apparatus 40 in advance. The terminal apparatus 40 selects an uplink transmission parameter from the set list. The antenna port of the reference signal and the index information of the uplink transmission parameter set are associated in advance. The terminal apparatus 40 selects the antenna port of the reference signal to be used, in accordance with the selected uplink transmission parameter. The base station 20 determines the uplink transmission parameter selected by the terminal apparatus 40 based on the antenna port of the reference signal.

Here, a difference between the conventional method and the means used by the base station 20 to preliminarily set the uplink transmission parameter set selectable by the terminal apparatus 40, in the terminal apparatus 40.

In the conventional method, the base station 20 sets a plurality of parameter sets including all the transmission parameters, in the terminal apparatus 40. The terminal apparatus 40 selects a transmission parameter set from a plurality of parameter sets that have been set, and performs uplink transmission.

On the other hand, in the present embodiment, the base station 20 sets a plurality of set candidates including a part of the transmission parameters, in the terminal apparatus 40. For example, here is an assumable case where the terminal apparatus 40 cannot select an uplink transmission resource and can select a transmission parameter other than the uplink transmission resource. At this time, the terminal apparatus 40 selects a set of transmission parameters from among a plurality of parameter sets that have been set, and performs uplink transmission. That is, in the present embodiment, some parameters are determined by the base station 20, but the remaining parameters are determined by the terminal apparatus 40 based on the assistance information.

### 3-6-2. Sequence Example

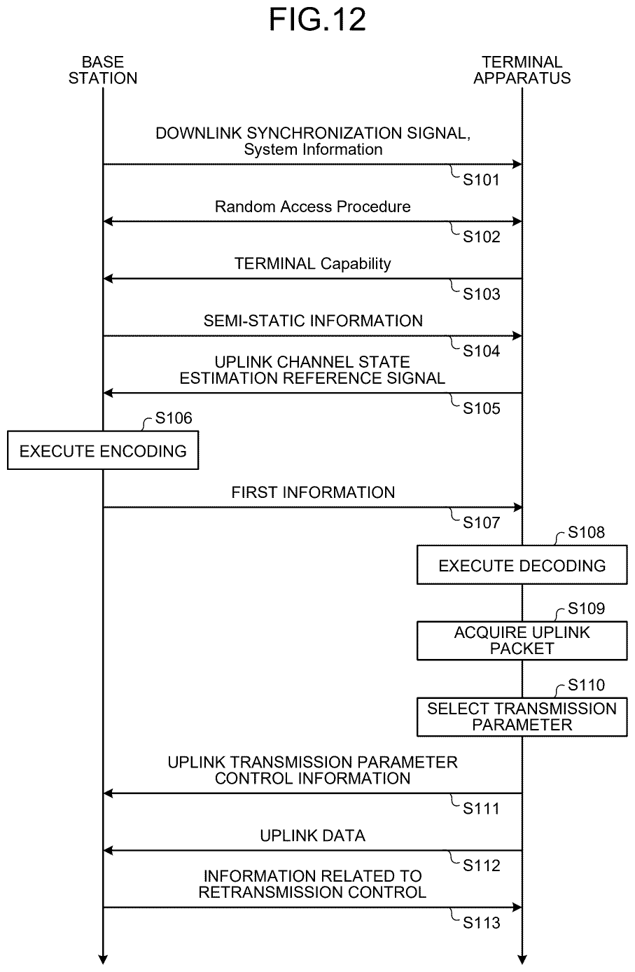

Based on the above, sequence examples of the Configured grant transmission processing of the present embodiment will be described. FIG. 12 is a sequence example illustrating Configured grant transmission processing of the present embodiment. The Configured grant transmission processing of the present embodiment will be described below with reference to FIG. 12.

First, the base station 20 transmits various signals/various information to the terminal apparatus 40. For example, the base station 20 transmits a downlink synchronization signal and system information to the terminal apparatus (Step S101). At this time, notification of information related to application of the learning model may be provided to the system information.

Subsequently, the base station 20 and the terminal apparatus 40 execute a random access procedure (Step S102). Thereafter, the terminal apparatus 40 notifies the base station 20 of its own capability related to signal processing (Step S103). For example, the terminal apparatus 40 notifies the base station 20 of capability information related to application of the learning model to signal processing.

Next, the base station 20 notifies the terminal apparatus 40 of semi-static information (for example, RRC signaling) (Step S104). At this time, the semi-static information may include information related to the uplink transmission grant that is set semi-statically. Furthermore, the semi-static information may include information related to application of the learning model.

Next, the terminal apparatus 40 transmits fourth information to be used for generating the assistance information T (third information) to another communication apparatus. At this time, the terminal apparatus 40 may transmit an uplink channel state estimation reference signal as the fourth information (Step S105).

The base station 20 receives the uplink channel state estimation reference signal from the terminal apparatus 40. Subsequently, the base station 20 generates assistance information T (third information) from the uplink channel state estimation reference signal (fourth information). At this time, the base station 20 may generate uplink channel state information as the assistance information T. Subsequently, the base station 20 encodes the assistance information T (Step S106). For example, the base station 20 generates the first information from the assistance information T by using the first model. Subsequently, the base station 20 transmits the first information to the terminal apparatus 40 (Step S107).

The terminal apparatus 40 receives the first information from the base station 20. Subsequently, the terminal apparatus 40 decodes the first information (Step S108). For example, the terminal apparatus 40 generates the assistance information R (second information) from the first information by using the second model. At this time, the terminal apparatus 40 may generate uplink channel state information as the assistance information R.

For example, at occurrence of an uplink packet, the terminal apparatus 40 performs uplink transmission (for example, the Configured Grant PUSCH) based on the uplink Grant (Configured Grant) and the assistance information R. At this time, the terminal apparatus 40 may perform uplink transmission as follows.

First, the terminal apparatus 40 acquires an internally generated uplink packet as transmission data (Step S109). The terminal apparatus 40 selects an optimum Configured grant transmission parameter based on the assistance information R (in the example of FIG. 12, uplink channel state information) (Step S110).

In a case where there is the uplink transmission parameter determined by the terminal apparatus 40 itself, the terminal apparatus 40 notifies the base station 20 of the uplink transmission parameter based on the above-described uplink transmission parameter notification means (Step S111).

Subsequently, the terminal apparatus 40 sets the selected Configured grant transmission parameter and executes uplink data transmission (Configured Grant transmission) based on the setting (Step S112).

Next, the base station 20 notifies the terminal apparatus 40 of information related to retransmission control (hereinafter, referred to as retransmission control information.) (Step S113). Here, the base station 20 may notify ACK/NACK information as the retransmission control information. The base station 20 may notify the retransmission control information by downlink control information such as DCI. At this time, the terminal apparatus 40 may operate as follows.

For example, in a case where the terminal apparatus 40 receives, from the base station 20, DCI of the same HARQ process number as the HARQ process number used in the Configured grant transmission, the Configured grant transmission may be regarded as a failure. At this time, the terminal apparatus 40 may perform retransmission based on the uplink transmission control information included in the received DCI.

For example, when the terminal apparatus 40 has received the DCI having the same HARQ process number as the HARQ process number used in the Configured grant transmission from the base station 20, the terminal apparatus determines whether the Configured grant transmission has been successful or has failed based on a new data indicator (NDI) included in the DCI. For example, in a case where the NDI indicates retransmission, the terminal apparatus 40 determines that the Configured grant transmission has failed. At this time, the terminal apparatus 40 performs retransmission based on the uplink transmission control information included in the received DCI. On the other hand, in a case where the NDI indicates the first transmission, the terminal apparatus 40 determines that the Configured grant transmission has been successful. At this time, the terminal apparatus 40 transmits new data based on the uplink transmission control information included in the received DCI.

For example, when there is a setting of a timer to determine that Configured grant transmission is successful, and when the DCI has not been received from the base station 20 within the period set by the timer, the terminal apparatus 40 may consider that the Configured grant transmission has been successful.

For example, when there is a setting of a timer to determine that Configured grant transmission is a failure, and when the DCI has not been received from the base station 20 within the present period of the timer, the terminal apparatus 40 may consider that the Configured grant transmission has failed.

### 3-7. Other Application Examples

The present embodiment is applicable to other than Configured Grant transmission. Hereinafter, some application examples of the present embodiment will be described.

### (1) Application to Handover (Hand Over)

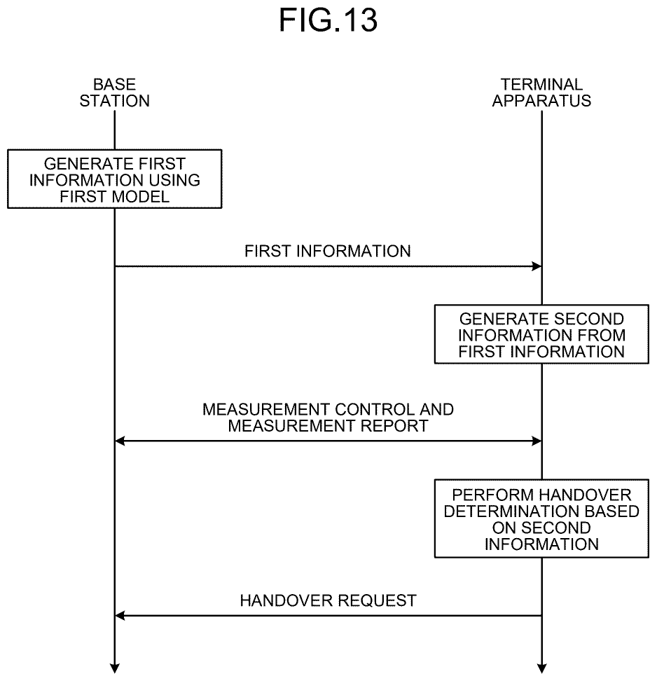

The present embodiment is also applicable to processing related to handover. FIG. 13 is a sequence example illustrating handover processing of the present embodiment. Hereinafter, the handover processing of the present embodiment will be described with reference to FIG. 13.

First, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information. The base station 20 and the terminal apparatus 40 perform measurement control and transmission of a measurement report. The communication processing unit 432 of the terminal apparatus 40 performs a handover determination based on the assistance information R (second information). Subsequently, the communication processing unit 432 of the terminal apparatus 40 makes a handover request to the base station 20 based on the determination result.

### (2) Application to Sidelink Communication

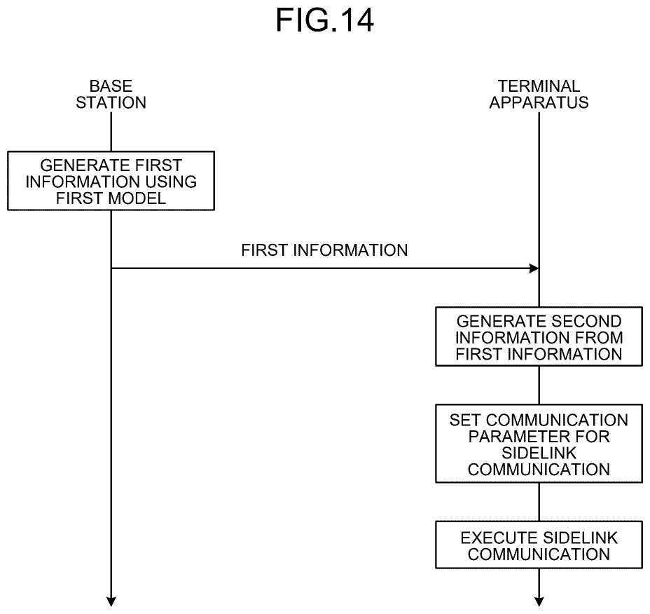

The present embodiment is also applicable to processing related to sidelink communication. FIG. 14 is a sequence example illustrating sidelink communication processing of the present embodiment. Hereinafter, the sidelink communication processing of the present embodiment will be described with reference to FIG. 14.

First, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information. The communication processing unit 432 of the terminal apparatus 40 sets a communication parameter for sidelink communication based on the assistance information R (second information). Subsequently, the communication processing unit 432 of the terminal apparatus 40 performs sidelink communication with another terminal apparatus 40 based on the communication parameter that has been set.

### (3) Application to Shared Band Communication

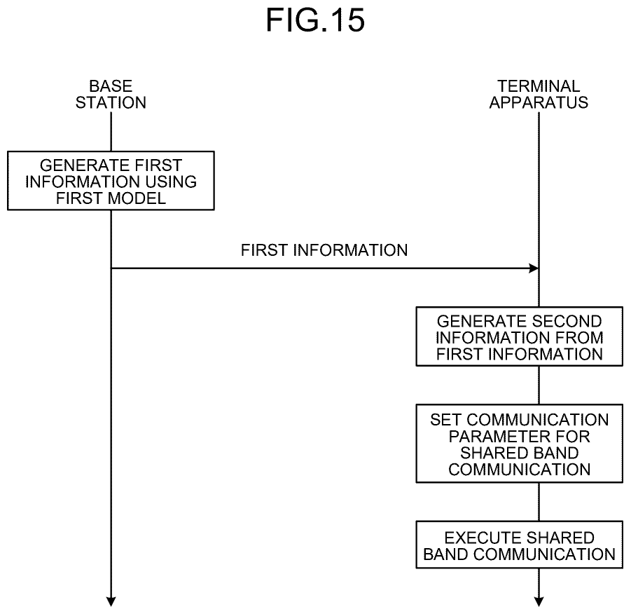

The present embodiment is also applicable to processing related to shared band communication. The shared band communication is communication performed using a band shared with another communication system (or another RAT). FIG. 15 is a sequence example illustrating a shared band communication processing of the present embodiment. Hereinafter, the shared band communication processing of the present embodiment will be described with reference to FIG. 15.

First, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information. The communication processing unit 432 of the terminal apparatus 40 sets the communication parameters for the shared band communication based on the assistance information R (second information). Subsequently, based on the set communication parameter, the communication processing unit 432 of the terminal apparatus 40 performs shared band communication with other communication apparatuses (for example, the base station 20 or another terminal apparatus 40).

### (4) Application to Uplink Communication

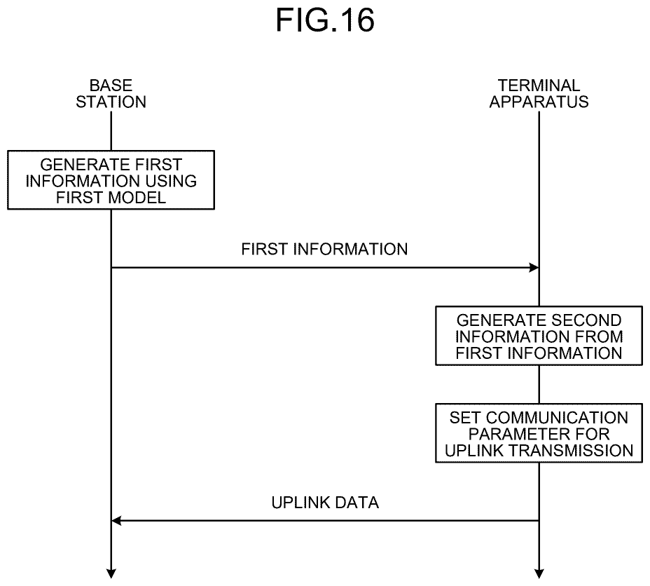

The present embodiment is also applicable to processing related to uplink communication (Grant Based). FIG. 16 is a sequence example illustrating uplink communication (Grant Based) of the present embodiment. The following describes the uplink communication processing of the present embodiment with reference to FIG. 16.

First, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information. The communication processing unit 432 of the terminal apparatus 40 sets a communication parameter for uplink communication based on the assistance information R (second information). Subsequently, the communication processing unit 432 of the terminal apparatus 40 transmits the uplink data to the base station 20 based on the set communication parameter.

### (5) Application to Configured Grant Communication

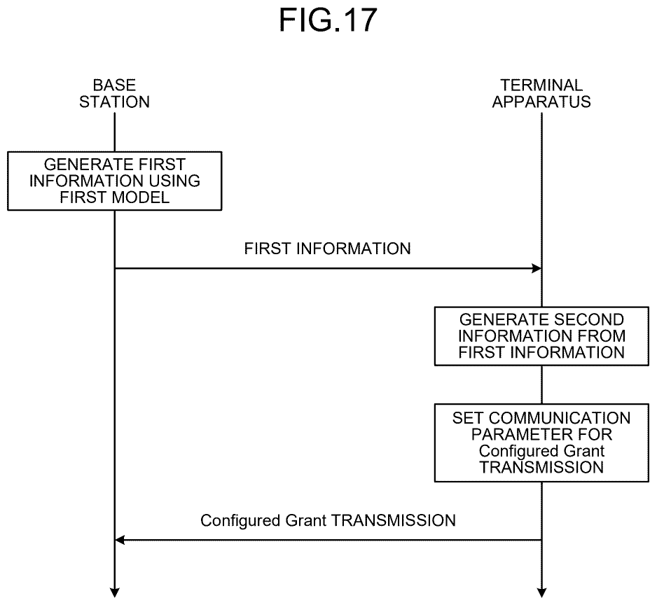

The present embodiment is also applicable to Configured Grant transmission. FIG. 17 is a sequence example illustrating Configured Grant transmission of the present embodiment. The Configured Grant transmission processing of the present embodiment will be described below with reference to FIG. 17.

First, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information. The communication processing unit 432 of the terminal apparatus 40 sets a communication parameter for uplink communication based on the assistance information R (second information). Subsequently, the communication processing unit 432 of the terminal apparatus 40 performs Configured Grant transmission based on the set communication parameter.

### (6) Other Sequence Examples

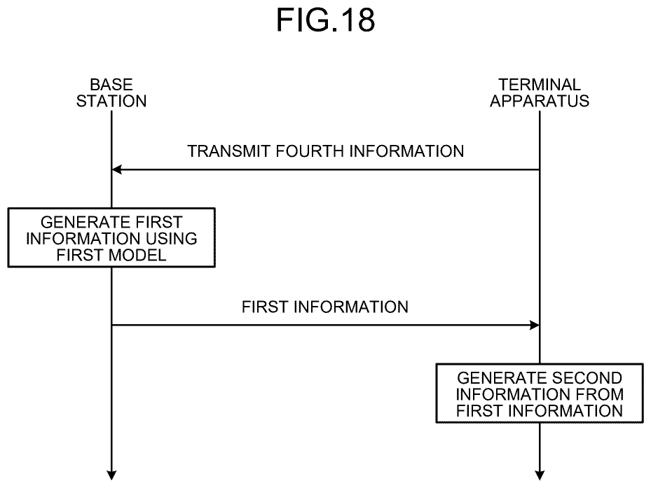

The above-described sequence examples are each illustrated as an example, and there can be other conceivable sequence examples. For example, the above-described assistance information T (third information) may be generated based on information provided from another communication apparatus. FIG. 18 is a diagram illustrating another sequence example. Hereinafter, another sequence example will be described with reference to FIG. 18.

First, the terminal apparatus 40 transmits fourth information used for generating the assistance information T (third information) to the base station 20. The generation unit 231 of the base station 20 generates assistance information T (third information) based on the fourth information. Subsequently, the generation unit 231 of the base station 20 generates the first information from the assistance information T (third information) using the first model. Subsequently, the communication processing unit 232 of the base station 20 transmits the first information to the terminal apparatus 40. The generation unit 431 of the terminal apparatus 40 generates the assistance information R (second information) from the first information.

### 4. Modifications

The above-described embodiment is an example, and various modifications and applications are possible.

In the above-described embodiment, the third information and the second information are assistance information (assistance information T or assistance information R), but the third information and the second information are not limited to the assistance information. The third information and the second information may be other control information or other user data.

In the above embodiment, the first information is the compressed information/feature information of the assistance information T. However, the first information is not limited to the compressed information/feature information of the assistance information T. The first information may be other control information or compressed information/feature information of other user data.

Furthermore, in the above-described embodiment, the first model is a learning model configured such that the data amount of the first information to be output is smaller than the data amount of the third information to be input. However, the first model is not necessarily limited to this example. The first model may be a learning model configured such that the data amount of the first information is the same or larger as compared to the data amount of the third information. The second model may be a learning model corresponding to such a first model. In addition, the first model may be configured such that other information can be input to the input layer in addition to the third information.

In addition, in the above-described embodiment, the first model and the second model are submodels of one learning model M, but the first model and the second model are not limited thereto. For example, the first model and the second model may be learning models trained separately.

Furthermore, in the above-described embodiment, the technology of the present disclosure has been described defining the base station 20 as the transmission apparatus and the terminal apparatus 40 as the reception apparatus. However, the application range of the present embodiment is not limited thereto. For example, the terminal apparatus 40 may function as a transmission apparatus that performs signal processing using the first model, or the base station 20 or the relay station 30 may function as a reception apparatus that performs signal processing using the second model. In addition, the technology of the present disclosure is also applicable to communication between a plurality of communication apparatuses selected from the base station 20, the relay station 30, and the terminal apparatus 40. Furthermore, the technology of the present disclosure is also applicable to communication between the base stations 20, between the relay stations 30, or between the terminal apparatuses 40. Furthermore, the technology of the present disclosure is also applicable to communication between the management apparatus 10 and another communication apparatus (for example, the base station 20, the relay station 30, the terminal apparatus 40, or another management apparatus 10).

Note that the function of each block (wireless communication unit 21, storage unit 22, and control unit 23) of the base station 20 may be similar to the function of each block (wireless communication unit 41, storage unit 42, and control unit 43) of the terminal apparatus 40, respectively. Furthermore, the function of each block (wireless communication unit 31, storage unit 32, and control unit 33) of the relay station 30 may be similar to the function of each block of the base station 20, or may be similar to each block of the terminal apparatus 40. Furthermore, the function of each block of the terminal apparatus 40 may be similar to the function of each block of the base station 20. Furthermore, the function of each block (communication unit 11, storage unit 12, and control unit 13) of the management apparatus 10 may be similar to the function of each block of the base station 20, or may be similar to the function of each block of the terminal apparatus 40.

A control apparatus that controls the management apparatus 10, the base station 20, the relay station 30, and the terminal apparatus 40 of the present embodiment may be actualized by a dedicated computer system or a general-purpose computer system.

For example, a communication program for executing the above-described operations is stored in a computer-readable recording medium such as an optical disk, semiconductor memory, a magnetic tape, or a flexible disk and distributed. For example, the program is installed on a computer and the above processing is executed to achieve the configuration of the control apparatus. At this time, the control apparatus may be an apparatus (for example, a personal computer) external to the management apparatus 10, the base station 20, the relay station 30, or the terminal apparatus 40. Furthermore, the control apparatus may be an internal apparatus (for example, the control unit 13, the control unit 23, the control unit 33, or the control unit 43) of the management apparatus 10, the base station 20, the relay station 30, or the terminal apparatus 40.

Furthermore, the communication program can be stored in a disk device included in a server on a network such as the Internet so as to be able to be downloaded to a computer, for example. Furthermore, the functions described above may be realized by using operating system (OS) and application software in cooperation. In this case, the portions other than the OS may be stored in a medium for distribution, or the portions other than the OS may be stored in a server so as to be downloaded to a computer, for example.

Furthermore, among individual processing described in the above embodiments, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of components of each apparatus/device is provided as a functional and conceptional illustration and thus does not necessarily need to be physically configured as illustrated. That is, the specific form of distribution/integration of each of The apparatuses is not limited to those illustrated in the drawings, and all or a part thereof can be functionally or physically distributed or integrated into optionally determined units in accordance with various loads and use status. This configuration by distribution or integration may be performed dynamically.

Furthermore, the above-described embodiments can be appropriately combined within a range implementable without contradiction of processing. Furthermore, the order of individual steps illustrated in the flowchart or the sequence diagram of the above-described embodiment can be altered as appropriate.

Furthermore, for example, the present embodiment can be implemented as any configuration constituting an apparatus or a system, for example, a processor as a large scale integration (LSI) or the like, a module using a plurality of processors or the like, a unit using a plurality of modules or the like, and a set obtained by further adding other functions to the unit, or the like (that is, a configuration of a part of the apparatus).

In the present embodiment, a system represents a set of a plurality of components (apparatuses/devices, modules (parts), or the like), and whether all the components are in the same housing would not be a big issue. Therefore, multiple apparatuses/devices housed in separate housings and connected via a network, and one apparatus/device in which multiple modules are housed in one housing, are both systems.

Furthermore, for example, the present embodiment can adopt a configuration of cloud computing in which one function is cooperatively shared and processed by a plurality of apparatuses or devices via a network.

### 6. Conclusion

As described above, transmission apparatus (for example, the base station 20) of the present embodiment generates first information (compressed information/feature information of the assistance information T) from the third information (the assistance information T) by using the first model. The transmission apparatus transmits the generated first information to the reception apparatus (for example, the terminal apparatus 40). The reception apparatus receives the first information from the transmission apparatus. Subsequently, the reception apparatus generates the second information (assistance information R) from the first information by using the second model corresponding to the first model. Subsequently, using the second information, the transmission apparatus executes processing related to wireless communication (for example, signal processing for data transmission to the transmission apparatus).

In this manner, in the present embodiment, both the transmission apparatus and the reception apparatus use the learning model to exchange information. Therefore, the communication apparatus (the transmission apparatus and the reception apparatus) of the present embodiment can achieve improvement in communication performance. For example, the learning model included in the communication apparatus of the present embodiment is configured such that the first information has a smaller data amount than the third information. This makes it possible for the communication system according to the embodiment to reduce the amount of information exchanged between the communication apparatuses, leading to improvement in the information transmission efficiency (improvement in frequency utilization efficiency).

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technology can also have the following configurations.
(1)
A communication apparatus comprising:
a communication processing unit configured to receive first information generated by using a first model, from another communication apparatus; and
a generation unit configured to generate second information from the first information by using a second model corresponding to the first model.
(2)
The communication apparatus according to (1),
wherein the first model is a model configured to generate the first information from third information, and
the second model is a model configured to generate the second information related to the third information, from the first information.
(3)
The communication apparatus according to (2),
wherein the first model is a learning model configured such that a data amount of the first information to be output is smaller than a data amount of the third information to be input.
(4)
The communication apparatus according to (2) or (3),
wherein the communication processing unit transmits fourth information used for generating the third information to the another communication apparatus.
(5)
The communication apparatus according to (4),
wherein the communication processing unit transmits at least one of a CSI-RS, an SRS, a DM-RS, a PRS, a PT-RS, a preamble, and an uplink reference signal, to the another communication apparatus as the fourth information.
(6)
The communication apparatus according to any one of (1) to (5),
wherein the second information includes at least one of information related to a channel state, index information based on a feedback table, position information of the communication apparatus or the another communication apparatus, and information related to a frequency use status.
(7)
The communication apparatus according to any one of (1) to (6),
wherein the communication processing unit executes processing related to sidelink communication based on the second information.
(8)
The communication apparatus according to any one of (1) to (6),
wherein the communication processing unit executes processing related to shared band communication based on the second information.
(9)
The communication apparatus according to any one of (1) to (6),
wherein the communication processing unit executes processing related to handover based on the second information.
(10)
The communication apparatus according to any one of (1) to (6),
wherein the communication processing unit executes processing related to uplink communication based on the second information.
(11)
The communication apparatus according to any one of (1) to (6),
wherein the communication processing unit sets a parameter for Configured Grant transmission based on the second information, and executes Configured Grant transmission based on the setting.
(12)
The communication apparatus according to any one of (1) to (11),
wherein the communication processing unit receives information related to the second model from the another communication apparatus.
(13)
The communication apparatus according to (12),
wherein the information related to the second model includes at least one of information related to a model type, number of nodes of an input layer at a start of learning, number of nodes of an output layer at the start of learning, network node layer configuration information, weight information, layer information, training data, and trained model information.
(14)
The communication apparatus according to any one of (1) to (13),
wherein the first model is a submodel of one learning model, and
the one learning model includes at least the first model and the second model, as the submodel.
(15)
The communication apparatus according to any one of (1) to (14),
wherein the communication processing unit receives, from the another communication apparatus, information related to application of processing of generating the second information by using the second model.
(16)
The communication apparatus according to (15),
wherein the information related to the application is information notification of which is semi-statically provided from the another communication apparatus.
(17)
The communication apparatus according to (15),
wherein the information related to the application is information notification of which is dynamically provided from the another communication apparatus.
(18)
A communication apparatus comprising:
a generation unit configured to generate first information by using a first model; and
a communication processing unit configured to transmit the first information to another communication apparatus capable of generating second information from the first information by using a second model corresponding to the first model.
(19)
A communication method comprising:
receiving first information generated by using a first model, from another communication apparatus; and
generating second information from the first information by using a second model corresponding to the first model.
(20)
A communication method comprising:
generating first information by using a first model; and
transmitting the first information to another communication apparatus capable of generating second information from the first information by using a second model corresponding to the first model.

### REFERENCE SIGNS LIST

1 COMMUNICATION SYSTEM
10 MANAGEMENT APPARATUS
20 BASE STATION
30 RELAY STATION
40 TERMINAL APPARATUS
11 COMMUNICATION UNIT
21, 31, 41 WIRELESS COMMUNICATION UNIT
12, 22, 32, 42 STORAGE UNIT
13, 23, 33, 43 CONTROL UNIT
211, 311, 411 TRANSMISSION UNIT
212, 312, 412 RECEPTION UNIT
213, 313, 413 ANTENNA
231, 331, 431 GENERATION UNIT
232, 332, 432 COMMUNICATION PROCESSING UNIT

1. A communication apparatus comprising:
a communication processing unit configured to receive first information generated by using a first model, from another communication apparatus; and
a generation unit configured to generate second information from the first information by using a second model corresponding to the first model.

2. The communication apparatus according to claim 1,
wherein the first model is a model configured to generate the first information from third information, and
the second model is a model configured to generate the second information related to the third information, from the first information.

3. The communication apparatus according to claim 2,
wherein the first model is a learning model configured such that a data amount of the first information to be output is smaller than a data amount of the third information to be input.

4. The communication apparatus according to claim 2,
wherein the communication processing unit transmits fourth information used for generating the third information to the another communication apparatus.

5. The communication apparatus according to claim 4,
wherein the communication processing unit transmits at least one of a CSI-RS, an SRS, a DM-RS, a PRS, a PT-RS, a preamble, and an uplink reference signal, to the another communication apparatus as the fourth information.

6. The communication apparatus according to claim 1,
wherein the second information includes at least one of information related to a channel state, index information based on a feedback table, position information of the communication apparatus or the another communication apparatus, and information related to a frequency use status.

7. The communication apparatus according to claim 1,
wherein the communication processing unit executes processing related to sidelink communication based on the second information.

8. The communication apparatus according to claim 1,
wherein the communication processing unit executes processing related to shared band communication based on the second information.

9. The communication apparatus according to claim 1,
wherein the communication processing unit executes processing related to handover based on the second information.

10. The communication apparatus according to claim 1,
wherein the communication processing unit executes processing related to uplink communication based on the second information.

11. The communication apparatus according to claim 1,
wherein the communication processing unit sets a parameter for Configured Grant transmission based on the second information, and executes Configured Grant transmission based on the setting.

12. The communication apparatus according to claim 1,
wherein the communication processing unit receives information related to the second model from the another communication apparatus.

13. The communication apparatus according to claim 12,
wherein the information related to the second model includes at least one of information related to a model type, number of nodes of an input layer at a start of learning, number of nodes of an output layer at the start of learning, network node layer configuration information, weight information, layer information, training data, and trained model information.

14. The communication apparatus according to claim 1,
wherein the first model is a submodel of one learning model, and
the one learning model includes at least the first model and the second model, as the submodel.

15. The communication apparatus according to claim 1,
wherein the communication processing unit receives, from the another communication apparatus, information related to application of processing of generating the second information by using the second model.

16. The communication apparatus according to claim 15,
wherein the information related to the application is information notification of which is semi-statically provided from the another communication apparatus.

17. The communication apparatus according to claim 15,
wherein the information related to the application is information notification of which is dynamically provided from the another communication apparatus.

18. A communication apparatus comprising:
a generation unit configured to generate first information by using a first model; and
a communication processing unit configured to transmit the first information to another communication apparatus capable of generating second information from the first information by using a second model corresponding to the first model.

19. A communication method comprising:
receiving first information generated by using a first model, from another communication apparatus; and
generating second information from the first information by using a second model corresponding to the first model.

20. A communication method comprising:
generating first information by using a first model; and
transmitting the first information to another communication apparatus capable of generating second information from the first information by using a second model corresponding to the first model.
